(19) United States
(12) Patent Application Publication
(10) Pub. No.: US 2026/0019527 A1
(43) Pub. Date: Jan. 15, 2026

(54) IMAGE FORMING SYSTEM AND DISPLAY METHOD FOR IMAGE FORMING APPARATUS

(71) Applicant: CANON KABUSHIKI KAISHA, Tokyo (JP)

(72) Inventor: MASASHI OYA, Saitama (JP)

(21) Appl. No.: 19/256,734

(22) Filed: Jul. 1, 2025

(30) Foreign Application Priority Data
Jul. 9, 2024 (JP) 2024-110603

(51) Int. Cl. H04N 1/60; G03G 15/00; G06F 3/12

(52) U.S. Cl. CPC H04N 1/6036; G03G 15/5058; G03G 15/5062; G06F 3/1208; G06F 3/1258; H04N 1/6027; H04N 1/6041; H04N 1/6044; H04N 1/6091; G03G 2215/0164

(57) ABSTRACT

A system including a printer which performs printing on a recording medium according to a print job includes a display configured to display information, acquires first color tones, on a member halfway through print processing, of at least a first print job and a second print job, and acquires second color tones, on the recording medium subjected to printing, of at least the first print job and the second print job, wherein the display displays first color information that is based on the first color tones of at least the first print job and the second print job and second color information that is based on the second color tones of at least the first print job and the second print job.

### BACKGROUND

### Field of the Technology

Aspects of the embodiments generally relate to displaying of a color variation in a printed product which is obtained by an image forming apparatus performing printing.

### Description of the Related Art

Recent on-demand image forming apparatuses (hereinafter referred to as a “printers”) have advanced in image quality and productivity, have become requiring less operator training time, and, therefore, have been progressively introduced as alternative machines of offset printing machines. However, since the image quality level of offset printing is high, the printers are currently limited to specific uses. To create a further growing market for the printers, ensuring an image quality higher than or equal to the image quality of offset printing is needed. What is especially important is an improvement in color stability.

Japanese Patent Application Laid-Open No. 2022-112771 discusses, as a color stabilizing technique for printers, gradation correction control for correcting the gradation of primary colors. The discussed technique for the gradation correction control reads, via a sensor, a printed product obtained by printing performed by a printer (a recording medium with a toner image recorded thereon), compares the color of the read printed product with a target color, determines a correction amount for bringing the color of the read printed product close to the target color, and corrects the input image data based on the determined correction amount, thus stabilizing colors in a print job. Additionally, the discussed technique displays, to the user, a correction amount which is being used for printing in progress in a plurality of print jobs and thus enables the user to recognize how the gradation correction control is acting on a variation having occurred.

### SUMMARY

According to an aspect of the embodiment, a system including a printer which performs printing on a recording medium according to a print job includes a display configured to display information, and a controller having one or more processors which execute instructions stored in one or more memories, the controller being configured to: acquire first color tones, on a member halfway through print processing, of at least a first print job and a second print job; and acquire second color tones, on the recording medium subjected to printing, of at least the first print job and the second print job, wherein the display displays first color information that is based on the first color tones of at least the first print job and the second print job and second color information that is based on the second color tones of at least the first print job and the second print job.

Features of the disclosure will become apparent from the following description of embodiments with reference to the attached drawings. The following description of embodiments are described by way of example.

### BRIEF DESCRIPTION OF THE DRAWINGS

FIG. 1 is a diagram illustrating an example of a network configuration of a printing system.

FIG. 2 is a sectional view illustrating an example of a hardware configuration of an image forming apparatus.

FIG. 3 is a block diagram illustrating internal configurations of the image forming apparatus, an external controller, and a client personal computer (PC).

FIGS. 4A and 4B are schematic diagrams illustrating the behavior of acquiring a color tone on an intermediate transfer belt serving as an image bearing member.

FIGS. 5A and 5B are schematic diagrams illustrating the behavior of acquiring a color tone on a recording medium.

FIG. 6 is a flowchart illustrating a processing procedure in an image adjustment unit in a first exemplary embodiment.

FIGS. 7A and 7B are schematic diagrams of screens for accepting settings of color tone variation detection.

FIGS. 8A, 8B, and 8C are schematic diagrams illustrating color tone variations in a plurality of printing processes.

FIG. 9 is a schematic diagram of a screen for displaying, to the user, a result of determination as to the necessity of adjustment that is based on a variation of color tone.

FIG. 10 is a schematic diagram illustrating an example of changing a density condition of toner which is displayed in a screen for displaying a variation of color tone.

FIG. 11 is a schematic diagram illustrating an example of accepting an instruction for referring to past data from the user in a screen for displaying a variation of color tone.

FIGS. 12A and 12B are schematic diagrams illustrating the behavior of acquiring a color tone on an intermediate transfer belt serving as an image bearing member in a case where a plurality of patches for color tone acquisition has been arranged.

FIGS. 13A and 13B are schematic diagrams illustrating the behavior of acquiring a color tone on a recording medium in a case where a plurality of patches for color tone acquisition has been arranged.

FIG. 14 is a flowchart illustrating a processing procedure in an image adjustment unit in a second exemplary embodiment.

FIG. 15 is a schematic diagram of a screen for accepting the designation of a color tone acquisition position from input image data.

FIGS. 16A and 16B are schematic diagrams illustrating the behavior of acquiring a color tone on an intermediate transfer belt serving as an image bearing member in the second exemplary embodiment.

FIGS. 17A and 17B are schematic diagrams illustrating the behavior of acquiring a color tone on a recording medium in the second exemplary embodiment.

FIGS. 18A and 18B are schematic diagrams illustrating the estimation of an engine state in the second exemplary embodiment.

FIGS. 19A, 19B, and 19C are schematic diagrams illustrating examples of displaying concerning differences between acquired color tones.

FIGS. 20A and 20B are schematic diagrams of screens for checking a long-term variation.

### DESCRIPTION OF THE EMBODIMENTS

Various exemplary embodiments, features, and aspects of the disclosure will be described in detail below with reference to the drawings. Furthermore, the following exemplary embodiments should not be construed to limit the disclosure set forth in claims, and not all of the combinations of features described in the exemplary embodiments are necessarily essential for solutions in the disclosure. While, in the description of the following exemplary embodiments, an image forming apparatus is used as an example of an information processing apparatus, the exemplary embodiments are not limited to such example.

In a first exemplary embodiment of the disclosure, on an intermediate transfer belt 308 serving as an image bearing member of a printing unit 107 described below, in addition to an input-image toner image caused by an input image, a patch toner image available for measuring a color tone is formed at a portion of the intermediate transfer belt 308 corresponding to the edge portion of a recording medium, and a color tone on the image bearing member is acquired by a density sensor 310. Additionally, images that are based on the above-mentioned input-image toner image and the above-mentioned patch toner image are formed on the recording medium, and a color tone of the patch on the recording medium is acquired by an image reading unit 331.

In the first exemplary embodiment, an example in which a toner application amount is used as a color tone is described. Furthermore, the color toner is not limited to the above-mentioned example. As long as it is a measure capable of expressing a difference in color of images, the color tone can be lightness, saturation, or hue. A variation is calculated from two color tones acquired in different printing processes, and color tone variation information indicating a color tone difference (lightness difference, saturation difference, or hue difference) is displayed during a print job in progress. Displaying the variation enables notifying, in real time, the user of the presence or absence of a printing process becoming a factor for the vibration.

While, in the first exemplary embodiment, an example of calculating a variation in toner application amount is described, it is desirable that the variation be of a form optimum according to a color tone to be acquired. For example, in a case where the above-mentioned lightness, saturation, or hue is acquired as a color tone, a color difference which is used as a measure for a difference in color in the field of color science can be used as a variation. In the following description, the detailed implementation method is described.

### <Overall Configuration of System>

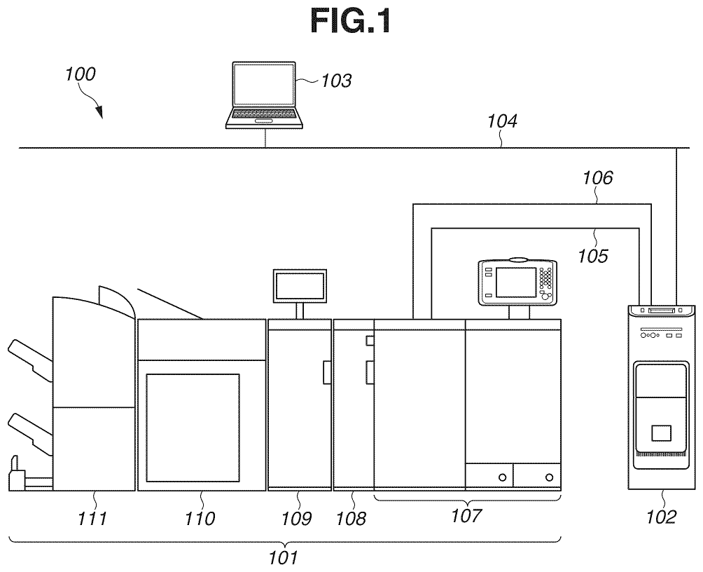

FIG. 1 is a diagram illustrating an example of a network configuration including a printing system (image forming system) according to the first exemplary embodiment. As illustrated in FIG. 1, the printing system 100 includes an image forming apparatus 101 and an external controller 102. The image forming apparatus 101 and the external controller 102 are interconnected via an internal local area network (LAN) 105 and a video cable 106 in such a way as to be able to communicate with each other. The external controller 102 is connected to a client personal computer (PC) 103 via an external LAN 104 in such a way as to be able to communicate with the client PC 103.

The client PC 103 is able to issue a printing instruction to the external controller 102 via the external LAN 104. The client PC 103 includes a printer driver installed thereon which has the function of converting image data serving as a print processing target into a page description language (PDL) which is processable by the external controller 102. The user, who wants to perform printing, can operate the client PC 103 to issue a printing instruction from various applications installed on the client PC 103 via the printer driver.

The printer driver transmits PDL data serving as print data to the external controller 102 based on a printing instruction received from the user. Upon receiving the PDL data from the client PC 103, the external controller 102 performs analysis and interpretation of the received PDL data. The external controller 102 performs rasterization processing based on a result of interpretation, generates a bit-mapped image (print image data) with a resolution tailored to the image forming apparatus 101, and inputs a print job to the image forming apparatus 101, thus issuing a printing instruction to the image forming apparatus 101.

Next, the image forming apparatus 101 is described. The image forming apparatus 101, to which devices having respective different functions are connected, is thus configured to be able to perform complicated print processing operations such as bookbinding. The image forming apparatus 101 includes a printing unit 107 (image forming unit), an inserter 108, an image inspection unit 109, a stacker 110, and a finisher 111. In the following description, such modules are described.

According to a print job, the printing unit 107 generates an image including a patch at a portion corresponding to the edge portion of a recording medium, and discharges a subjected-to-printing recording medium with the image recorded thereon. The subjected-to-printing recording medium discharged from the printing unit 107 is conveyed inside the respective units in the order of the image inspection unit 109, the stacker 110, and the finisher 111. Moreover, the printing unit 107 is equipped with a density sensor 310, which acquires a color tone on an image bearing member serving as a conveyance path in the process of printing an image on a recording medium, and thus acquires a color tone on the image bearing member.

While, in the first exemplary embodiment, the image forming apparatus 101 of the printing system 100 is an example of an image forming apparatus, the printing unit 107 included in the image forming apparatus 101 may be referred to as an image forming apparatus.

The printing unit 107 forms (prints) an image on a recording medium, which is fed and conveyed from a paper feed unit located in a lower portion of the printing unit 107, with use of toner (color material).

Moreover, upon receiving an instruction for correction measures issued by an operation performed by the user or issued by the image inspection unit 109 described below, the printing unit 107 performs printing of a test chart corresponding to the correction measures selected from a preliminarily retained test chart group. Additionally, the image reading unit 331 reads a printed product obtained by performing printing, and thus acquires image data. Then, based on a result of reading of the printed product, the image inspection unit 109 performs, for example, main scanning unevenness correction for adjusting the uniformity of an image density, automatic gradation correction for maintaining the gradation of a maximum density or a single color, adjustment of a secondary transfer voltage, and automatic color tone correction for adjusting the variation of a multidimensional color.

The inserter 108 is a device which is used to insert an insertion sheet. The inserter 108 is able to insert an insertion sheet into a group of sheets of paper subjected to printing and conveyed by the printing unit 107. Furthermore, the inserter 108 is not relevant to the gist of the aspect of the embodiments and is, therefore, not described and illustrated in the following description.

Based on a recording medium subjected to printing, on which an image has been printed by the printing unit 107 and which has been conveyed through a conveyance path, the image inspection unit 109 acquires a color tone on the recording medium with use of the image reading unit 331. The image inspection unit 109 acquires the variation of the acquired color tone on the recording medium and the variation of a color tone on an image bearing member acquired by the density sensor 310 included in the printing unit 107, and thus causes the variations of color tones to be displayed on a user interface (UI) display unit 215 described below. Additionally, the image inspection unit 109 causes, in addition to two variations of color tones on the recording medium and on the image bearing member, a comparison result which is a difference obtained by comparing the two variations of color tones with each other to be displayed on the UI display unit 215, and determines the presence or absence of the necessity of image adjustment for the printing unit 107. The method of acquiring the variation of a color tone and the details of determination processing for determining the necessity of image adjustment are described below.

The stacker 110 is a device which is able to stack therein a large number of recording media subjected to printing. The finisher 111 is a device which is able to perform finishing processing, such as staple processing, punch processing, or saddle stitch binding processing, on the conveyed recording media subjected to printing. The recording media subjected to finishing processing by the finisher 111 are discharged to a predetermined discharge tray.

While, in the configuration example illustrated in FIG. 1, the external controller 102 is connected to the image forming apparatus 101, the first exemplary embodiment can be applied to a configuration different from the illustrated configuration example. For example, a configuration in which the image forming apparatus 101 is connected to the external LAN 104 and print data is transmitted from the client PC 103 to the image forming apparatus 101 without via the external controller 102 can be employed. In this case, data analysis and rasterization for print data are performed by the image forming apparatus 101.

### <Hardware Configuration of Image Forming Apparatus 101>

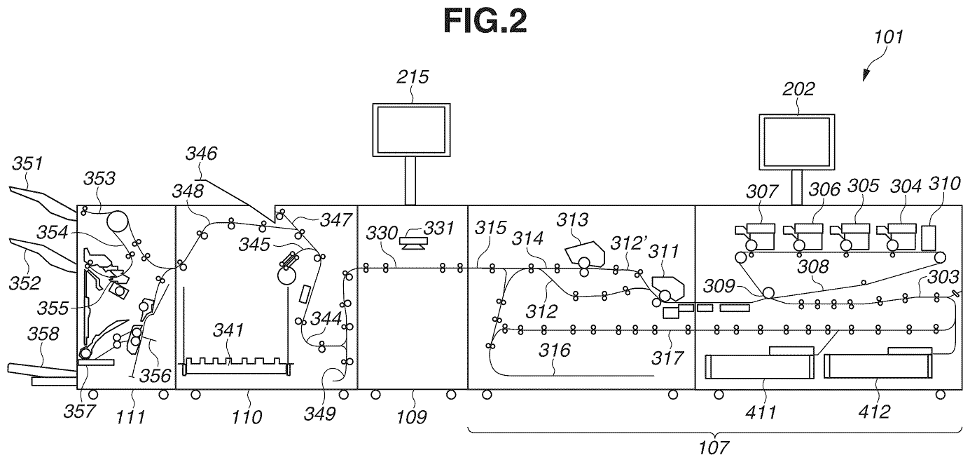

FIG. 2 is a sectional view illustrating an example of a hardware configuration of the image forming apparatus 101. In the following description, a specific operation example of the image forming apparatus 101 is described with reference to FIG. 2.

The printing unit 107 includes a plurality of paper feed decks. In the first exemplary embodiment the printing unit 107 includes two types of paper feed decks, i.e., paper feed decks 411 and 412. Respective ones of various types of recording media (sheets of paper) are stored in the paper feed decks 411 and 412. From among recording media stored in each of the paper feed decks 411 and 412, a recording medium located at the top is separated one by one and is fed to a conveyance path 303. Moreover, image forming stations 304 to 307 include respective photosensitive drums (photosensitive members), and form respective toner images on the photosensitive drums with use of respective different color toners. Specifically, the image forming stations 304 to 307 form respective toner images with use of yellow (Y), magenta (M), cyan (C), and black (K) toners, respectively.

Respective color toner images formed in the image forming stations 304 to 307 are sequentially transferred onto the intermediate transfer belt 308 in a superposed manner (this operation being primary transfer). The toner images transferred to the intermediate transfer belt 308 are conveyed to a secondary transfer position 309 according to the rotation of the intermediate transfer belt 308. In the first exemplary embodiment, the printing unit 107 forms, in addition to the toner images that are based on input image data, a patch for acquiring a color tone on the intermediate transfer belt 308. The density sensor 310 measures the formed patch, thus acquiring a color tone on the intermediate transfer belt 308.

The density sensor 310 is configured with a light emitting portion and a light receiving portion, in which light emitted from the light emitting portion is reflected by the surface of the intermediate transfer belt 308 serving as an image bearing member, and the reflected light is measured by the light receiving portion. The density sensor 310 acquires luminance values based on a ratio between the light emitted from the light emitting portion and the reflected light. The density sensor 310 calculates a toner amount based on a preliminarily prepared conversion table for converting luminance values into toner application amounts. The processing for calculating a toner amount from a luminance value is described below.

At a secondary transfer position 309, the toner images are transferred from the intermediate transfer belt 308 to a recording medium which has been conveyed through the conveyance path 303 (this operation being secondary transfer). The recording medium subjected to secondary transfer is conveyed to a fixing unit 311. The fixing unit 311 includes a pressure roller and a heating roller. Heat and pressure are applied to the recording medium during while the recording medium is passing through between the pressure roller and the heating roller, so that fixing processing for fixing the toner images to the recording medium is performed. The recording medium, which has passed through the fixing unit 311, passes through a conveyance path 312 and is then conveyed to a connection point 315, at which the printing unit 107 and the image inspection unit 109 are interconnected. In this way, a color image is formed (printed) on the recording medium.

In a case where different fixing processing is required depending on a type of recording medium, the recording medium, which has passed through the fixing unit 311, is guided to a conveyance path 314 in which a fixing unit 313 is provided. The fixing unit 313 performs additional fixing processing on a recording medium which is conveyed through the conveyance path 314. The recording medium, which has passed through the fixing unit 313, is conveyed to the connection point 315. Moreover, in a case where an operation mode for performing two-sided printing is currently set, an image is printed on the first surface of the recording medium and the recording medium, which has been conveyed through the conveyance path 312 and the conveyance path 314, is guided to a reversing path 316.

The recording medium reversed by the reversing path 316 is guided to a two-sided conveyance path 317 and is then conveyed to the secondary transfer position 309. With this operation, at the secondary transfer position 309, toner images are transferred to the second surface of the recording medium, which is opposite to the first surface. After that, the recording medium passes through the fixing unit 311 (and the fixing unit 313), so that the formation of a color image on the second surface of the recording medium is complete. The recording medium subjected to printing, on which the formation (printing) of an image in the printing unit 107 is complete and which has been conveyed to the connection point 315, is conveyed to the inside of the image inspection unit 109.

The image inspection unit 109 includes the image reading unit 331, which includes a contact image sensor (CIS) on a conveyance path 330, through which the recording medium subjected to printing is conveyed from the printing unit 107. The image reading unit 331 is arranged to read the upper surface (first surface) of a recording medium. Furthermore, the image reading unit 331 can be configured with, instead of a CIS, for example, a charge-coupled device (CCD) sensor or a line scan camera.

The image reading unit 331 acquires, as a color tone, signal values of a color image of red (R), green (G), and blue (B) (RGB) channels. The image reading unit 331 calculates a toner amount based on a preliminarily prepared conversion table for converting RGB values into a toner application amount. The details of the processing for calculating a toner amount from RGB values are described below. The image inspection unit 109 calculates variations from two color tones in the respective different printing processes and displays the calculated variations on the UI display unit 215, thus notifying the user of the real-time variations of color tones during a print job in progress. Additionally, the image inspection unit 109 also determines the necessity of correction measures in the printing unit 107 based on the variations in the respective printing processes and a difference therein between the respective printing processes. Recording media, each of which has passed through the image inspection unit 109, are sequentially conveyed to the stacker 110 one by one. The specific processing operation of the image inspection unit 109 is described below.

The stacker 110 includes a stack tray 341, which serves as a tray on which to stack recording media subjected to printing sequentially conveyed from the image inspection unit 109, which is arranged on the upstream side in the conveyance direction of a recording medium subjected to printing. The recording medium subjected to printing, which has passed through the image inspection unit 109, is conveyed through a conveyance path 344 inside the stacker 110. The recording medium subjected to printing being conveyed through the conveyance path 344 is guided to a conveyance path 345, so that the guided recording medium subjected to printing is stacked on the stack tray 341. The stacker 110 further includes an escape tray 346 serving as a discharge tray.

In the first exemplary embodiment, the escape tray 346 is used to discharge a printed product the color tone of which is determined by the image inspection unit 109 to have varied. The printed product the color tone of which is determined to have varied being conveyed through the conveyance path 344 is guided to a conveyance path 347 and is thus conveyed to the escape tray 346. The recording medium subjected to printing being conveyed without being stacked or discharged in the stacker 110 is conveyed through a conveyance path 348 to the finisher 111, which is a stage subsequent to the stacker 110.

The stacker 110 further includes a reversing portion 349 which is used to reverse the orientation of a recording medium subjected to printing being conveyed. The reversing portion 349 is used to make the orientation of a recording medium which has been input to the stacker 110 and the orientation of a recording medium which has been stacked on the stack tray 341 and is then output from the stacker 110 equal to each other. Furthermore, the reversing operation by the reversing portion 349 is not performed on a recording medium subjected to printing which is conveyed to the finisher 111 without being stacked in the stacker 110.

The finisher 111 executes a finishing function designated by the user on recording media subjected to printing sequentially conveyed from the stacker 110, which is arranged on the upstream side in the conveyance direction of a recording medium subjected to printing. In the first exemplary embodiment, the finisher 111 includes, for example, finishing functions such as a staple function (one-place binding or two-place binding), a punch function (two holes or three holes), and a saddle stitch binding function. The finisher 111 includes two discharge trays 351 and 352.

In a case where finishing processing by the finisher 111 is not performed, a recording medium subjected to printing which has been conveyed to the finisher 111 is discharged through a conveyance path 353 to the discharge tray 351. In a case where finishing processing such as staple processing is performed by the finisher 111, recording media subjected to printing which have been conveyed to the finisher 111 are guided to a conveyance path 354. The finisher 111 uses a finishing processing portion 355 to perform finishing processing designated by the user on the recording media subjected to printing which have been conveyed through the conveyance path 354. Then, the finisher 111 discharges, to the discharge tray 352, the recording media subjected to printing on which the designated finishing processing has been performed.

### <Functional Configuration Diagram>

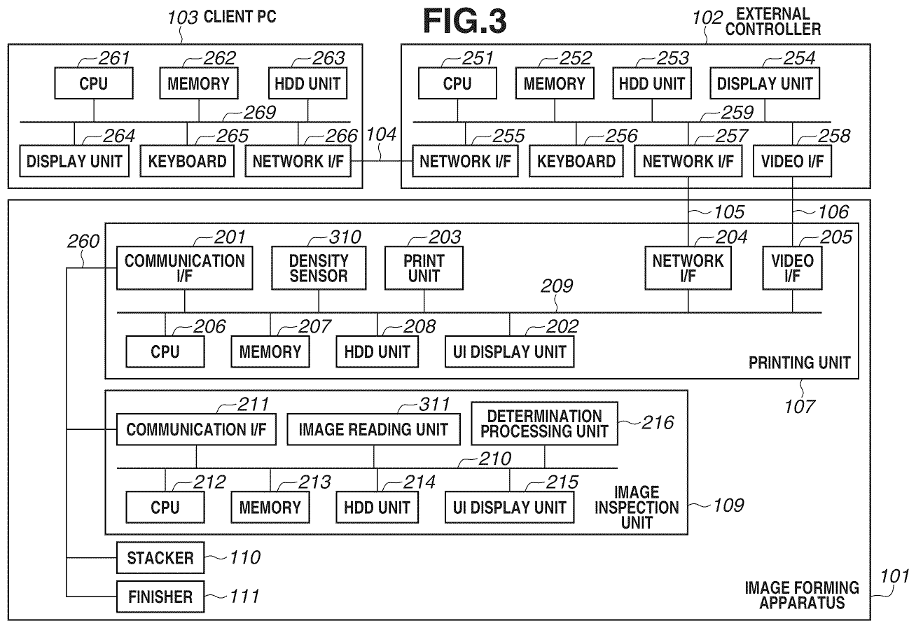

FIG. 3 is an outline functional block diagram of the image forming apparatus 101, the external controller 102, and the client PC 103.

The printing unit 107 of the image forming apparatus 101 includes a communication interface (I/F) 201, a network I/F 204, a video I/F 205, a central processing unit (CPU) 206, a memory 207, a hard disk drive (HDD) unit 208, and a user interface (UI) display unit 202. The printing unit 107 further includes a print unit 203 and a density sensor 310. These units of the printing unit 107 are interconnected via a system bus 209 in such a way as to be able to transmit and receive data to and from each other. The communication I/F 201 is connected to the image inspection unit 109, the stacker 110, and the finisher 111 via a communication cable 260.

The CPU 206 controls the communication I/F 201 to perform communications for controlling the respective devices. The network I/F 204 is connected to the external controller 102 via the internal LAN 105, and is used for communications of, for example, control data. The video I/F 205 is connected to the external controller 102 via the video cable 106, and is used for communication of data such as image data.

Furthermore, the printing unit 107 (the image forming apparatus 101) and the external controller 102 can be interconnected via only the video cable 106 as long as controlling an operation of the image forming apparatus 101 by the external controller 102 is possible. The HDD unit 208 stores various programs and various pieces of data. The CPU 206 controls operations of the entire printing unit 107 by executing a program stored in the HDD unit 208. In one embodiment, the memory 207 stores programs and data which are required for the CPU 206 to perform various processing operations. The memory 207 operates as a work area for the CPU 206.

The UI display unit 202 is used to accept inputting of various settings and an instruction for operations performed by the user and display various pieces of information such as setting information and a processing status of a print job. In the first exemplary embodiment, the user uses the UI display unit 202 to switch settings as to whether to perform color tone variation detection during printing in progress.

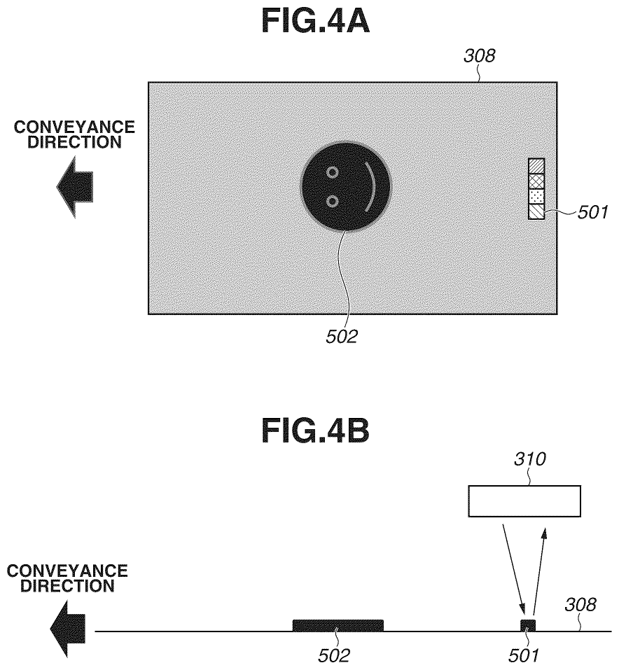

Moreover, under the control of the CPU 206, the printing unit 107 measures color tones on the intermediate transfer belt 308 inside the print unit 203 with use of the density sensor 310, and stores luminance values of the measured color tones in the memory 207. FIGS. 4A and 4B are schematic diagrams illustrating a relationship between toner images on the intermediate transfer belt 308 and the density sensor 310 taken when the printing unit 107 acquires luminance values.

FIG. 4A is a plane view of the intermediate transfer belt 308 as viewed from the position facing the intermediate transfer belt 308, and FIG. 4B is a sectional view of the intermediate transfer belt 308 as viewed from the position paralleling the intermediate transfer belt 308. In the example illustrated in FIGS. 4A and 4B, in addition to a toner image 502 corresponding to the input image, a patch 501 for measuring a color tone is arranged at a position of the intermediate transfer belt 308 corresponding to the trailing edge portion of a recording medium. The patch 501 includes patch portions the number of which is equal to the number of colors of toners. In the first exemplary embodiment, since the printing unit 107 is loaded with toners of four colors, i.e., cyan (C), magenta (M), yellow (Y), and black (K) (CMYK), four respective different patch portions are arranged. Each of the patch portions to be used is a single-color patch with an area ratio of 50%. The density sensor 310 emits light to the patch 501 and then measures light reflected from the patch 501, thus acquiring luminance values serving as a color tone on an image bearing member. The area ratio is an application amount of toner per unit area, and is an index representing a toner density. The details of this processing operation are described below. The stored luminance values are referred to by the image inspection unit 109 described below. The details of this processing operation are also described below.

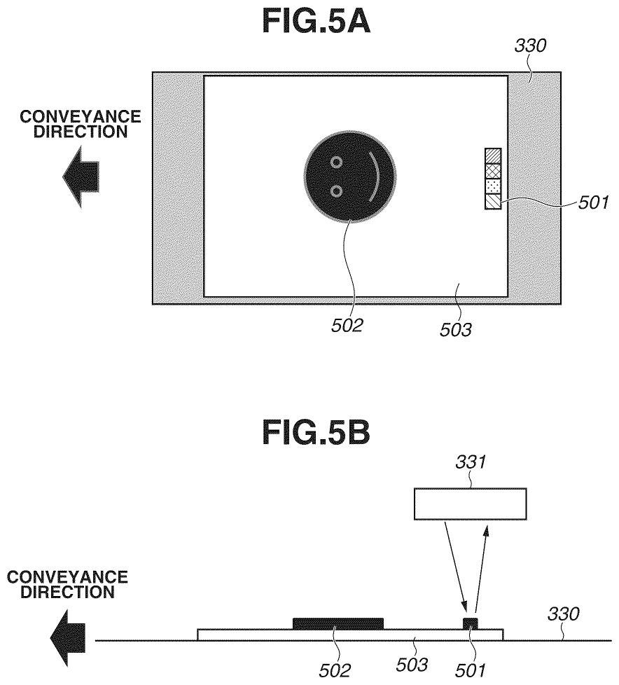

The image inspection unit 109 includes a communication I/F 211, a CPU 212, a memory 213, an HDD unit 214, an image reading unit 331, a determination processing unit 216, and a UI display unit 215. These units are interconnected via a system bus 210 in such a way as to be able to transmit and receive data to and from each other. The communication I/F 211 is connected to the printing unit 107 via the communication cable 260. The CPU 212 performs communications for controlling of the image inspection unit 109 via the communication I/F 211. The CPU 212 controls an operation of the image inspection unit 109 by loading a control program stored in the HDD unit 214 onto the memory 213 and executing the control program. The HDD unit 214 stores a control program for the image reading unit 331 and a processing program for performing the necessity determination of correction measures in the printing unit 107 which is performed by the determination processing unit 216. According to an instruction from the CPU 212, the image reading unit 331 acquires RGB values serving as a color tone of the conveyed printed product. FIGS. 5A and 5B are schematic diagrams illustrating a relationship between a toner image on a recording medium and the image reading unit 331 taken when the image reading unit 331 acquires RGB values.

FIGS. 5A and 5B illustrate an example in which the toner images on the intermediate transfer belt 308 illustrated in FIGS. 4A and 4B have been transferred and fixed to a recording medium 503 and have then been conveyed to the conveyance path 330. As with FIGS. 4A and 4B, FIG. 5A is a plane view of the conveyance path 330 and the recording medium 503 as viewed from the position facing the conveyance path 330, and FIG. 5B is a sectional view of the conveyance path 330 and the recording medium 503 as viewed from the position paralleling the conveyance path 330. In the example illustrated in FIGS. 5A and 5B, the image reading unit 331 reads the patch 501 formed on the recording medium 503. The image reading unit 331 acquires RGB signal values serving as a color tone of each patch portion. The CPU 212 converts the RGB values and the luminance value acquired by the density sensor 310 into respective toner amounts, and calculates the presence or absence of variations from a difference between the toner amounts obtained by conversion and toner amounts serving as targets. Additionally, the CPU 212 determines the necessity of correction measures in the printing unit 107 based on the presence or absence of two variations and a difference therein between the respective printing processes.

The UI display unit 215 displays a variation of color tone on the image bearing member and a variation of color tone on the recording medium 503. Additionally, the UI display unit 215 is used for displaying of a difference between two variations, a result of determination of the necessity of correction measures that are based on the variations and the difference, and an adjustment instruction. The UI display unit 215 is also used as an operation instruction unit used for the user to issue an instruction to the image inspection unit 109, and is operated by the user to accept various instructions from the user. The UI display unit 215 accepts, for example, an instruction for image adjustment measures and an instruction for changing the display content.

The stacker 110 performs control as to whether to discharge the recording medium subjected to printing which has been conveyed through the conveyance paths to the stack tray 341, discharge such a recording medium to the escape tray 346, or convey such a recording medium to the finisher 111, which is connected to the downstream side in the conveyance direction of a recording medium subjected to printing.

The finisher 111 controls conveyance and discharging of recording media subjected to printing to perform finishing processing such as staple processing, punch processing, or saddle stitch binding processing on the recording media.

The external controller 102 includes a CPU 251, a memory 252, an HDD unit 253, a keyboard 256, a display unit 254, network I/Fs 255 and 257, and a video I/F 258. These units are interconnected via a system bus 259 in such a way as to be able to transmit and receive data to and from each other.

The CPU 251 executes a program stored in the HDD unit 253 to control operations of the entire external controller 102, such as reception of print data from the client PC 103, raster image processor (RIP) processing, and transmission of print data to the image forming apparatus 101. The memory 252 stores programs and data required for the CPU 251 to perform various processing operations. The memory 252 operates as a work area for the CPU 251.

The HDD unit 253 stores various programs and various pieces of data. The keyboard 256 is used for inputting of an operation instruction for the external controller 102 issued by the user. The display unit 254 is, for example, a display, and is used for displaying of information about an application which is being executed in the external controller 102 and an operation screen.

The network I/F 255 is connected to the client PC 103 via the external LAN 104, and is used for communications of data such as a printing instruction. The network I/F 257 is connected to the image forming apparatus 101 via the internal LAN 105, and is used for communications of data such as a printing instruction. The external controller 102 is connected to the printing unit 107, the image inspection unit 109, the stacker 110, and the finisher 111 via the internal LAN 105 and the communication cable 260 in such a way as to be able to communicate with each other. The video I/F 258 is connected to the image forming apparatus 101 via the video cable 106, and is used for communications of data such as image data (print data).

The client PC 103 includes a CPU 261, a memory 262, an HDD unit 263, a display unit 264, a keyboard 265, and a network I/F 266. These units are interconnected via a system bus 269 in such a way as to be able to transmit and receive data to and from each other. The CPU 261 executes a program stored in the HDD unit 263 to control an operation of each unit via the system bus 269.

With this execution, various processing operations by the client PC 103 are implemented. For example, the CPU 261 executes a document processing program stored in the HDD unit 263 to perform generation of print data and issue a printing instruction. The memory 262 stores programs and data required for the CPU 261 to perform various processing operations. The memory 262 operates as a work area for the CPU 261.

The HDD unit 263 stores various applications such as a document processing program, programs such as a printer driver, and various pieces of data. The display unit 264 is, for example, a display, and is used for displaying of an application which is being executed in the client PC 103 and an operation screen. The keyboard 265 is used for inputting of an operation instruction for the client PC 103 issued by the user. The network I/F 266 is connected to the external controller 102 via the external LAN 104 in such a way as to be able to communicate with each other. The CPU 261 communicates with the external controller 102 via the network I/F 266.

### <Processing Flow in Determination Processing Unit 216>

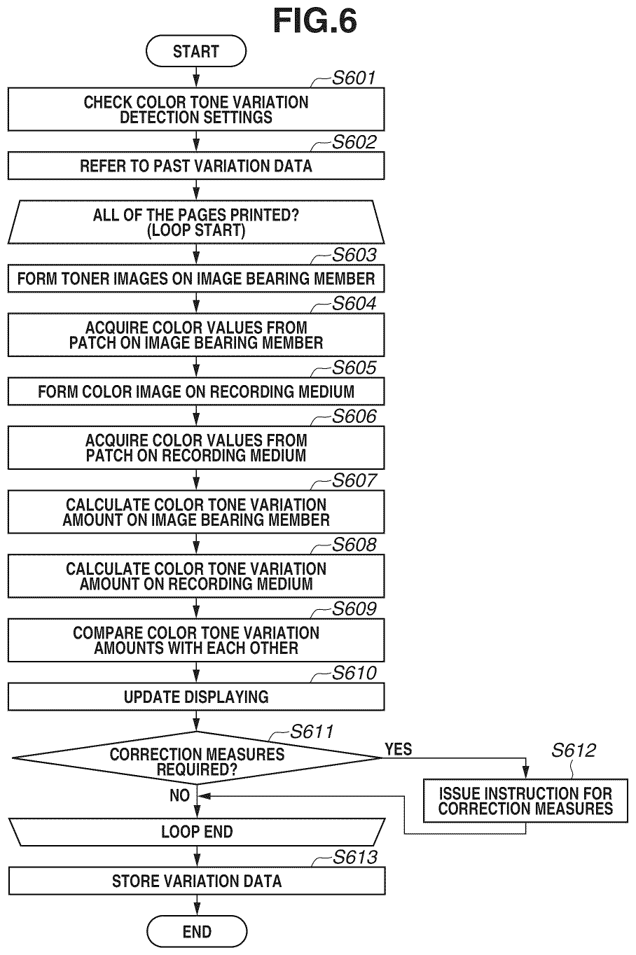

Determination processing which is performed in the image inspection unit 109 according to the first exemplary embodiment is described with reference to FIG. 6. FIG. 6 is a flowchart illustrating a processing procedure for causing the image inspection unit 109 to calculate variations of color tones during a print job in progress which is executed by the printing unit 107 and displaying a result of the calculation. Furthermore, FIG. 6 illustrates the entire flow starting with settings for performing color tone variation detection until the ending of a print job. Processing operations in the respective steps illustrated in FIG. 6 are performed by the CPU 206 of the printing unit 107 and the CPU 212 of the image inspection unit 109.

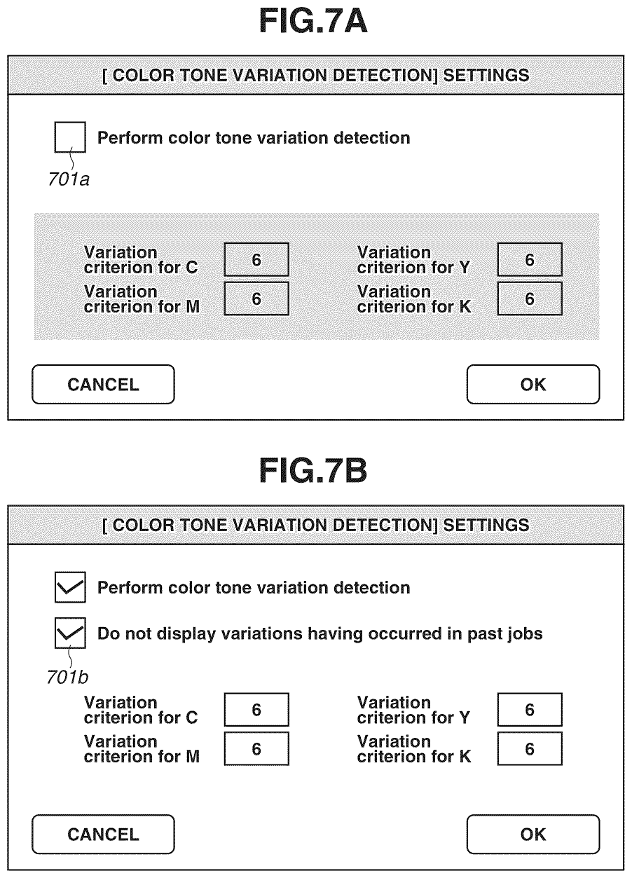

First, in step S601, the CPU 206 accepts an execution of color tone variation detection based on an instruction issued by the user via the UI display unit 202. FIGS. 7A and 7B are schematic diagrams of screens each for accepting an instruction from the user. FIG. 7A illustrates an initial screen which is displayed before the acceptance of an instruction from the user. Until a check instruction to a check box 701a is accepted, an input portion for variation criteria for the respective color materials is grayed out and is thus in a state of being unable to accept inputs. In response to the check box 701a being checked, graying-out of the input portion for variation criteria for the respective color materials is cancelled, so that it becomes possible to accept an instruction for a variation criterion value from the user. The variation criterion value is input from the user with use of, for example, a numeric keyboard (not illustrated).

When, upon acceptance of an execution instruction for color tone variation detection, a print job is performed, the CPU 206 and the CPU 212 perform processing operations in step S602 and subsequent steps. Processing operations in step S603 to step S612 are processing operations which are performed on a page-by-basis. In a case where the print job is data configured with a plurality of pages, step S603 to step S612 are repeatedly performed for every page and are repeated until printing for all of the pages included in the print job is complete.

In step S602, the CPU 212 acquires variation data about past print jobs stored in the HDD unit 214. The CPU 212 loads the acquired variation data onto the memory 213, and, additionally, controls the UI display unit 215 to display the variation data.

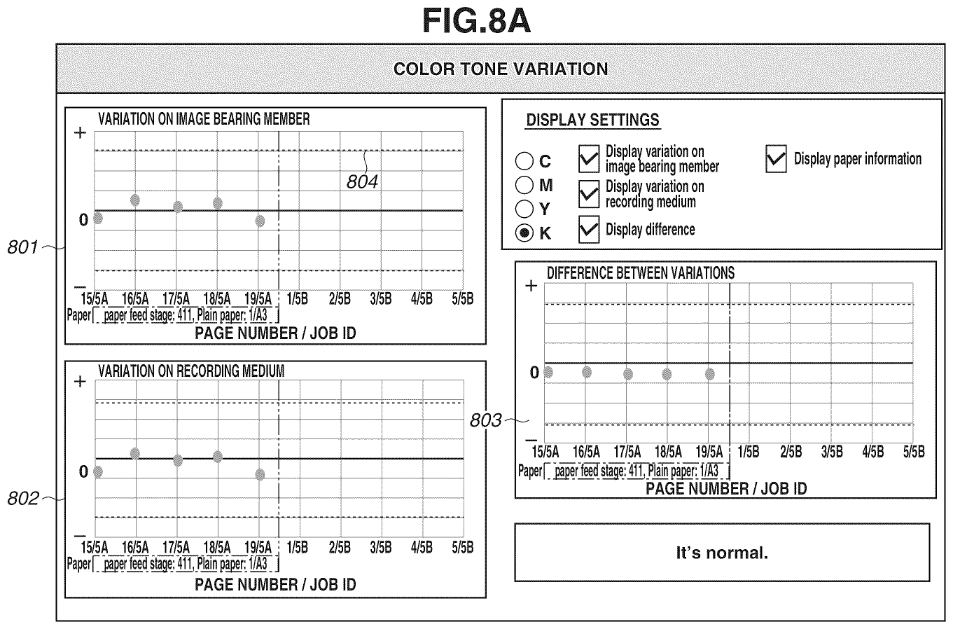

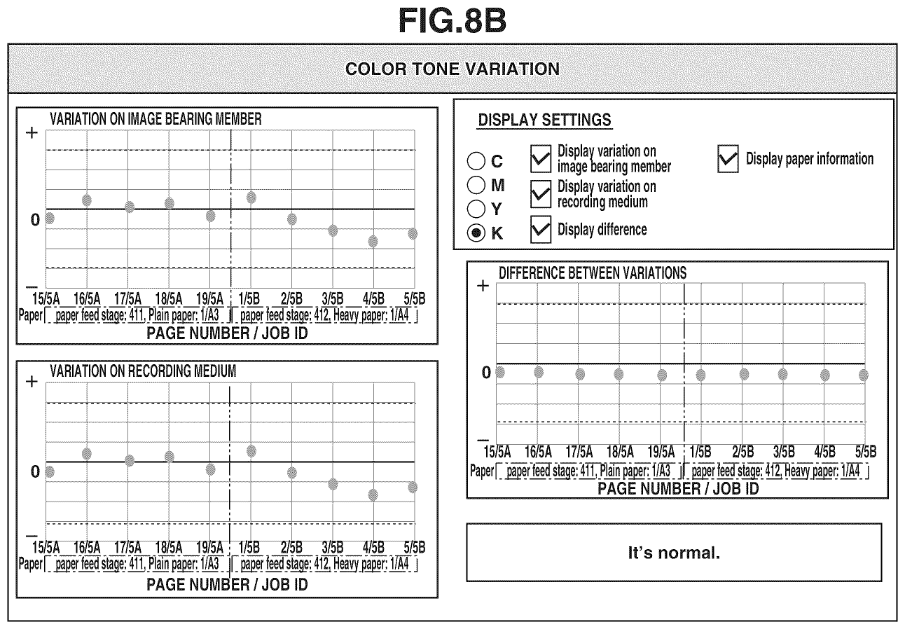

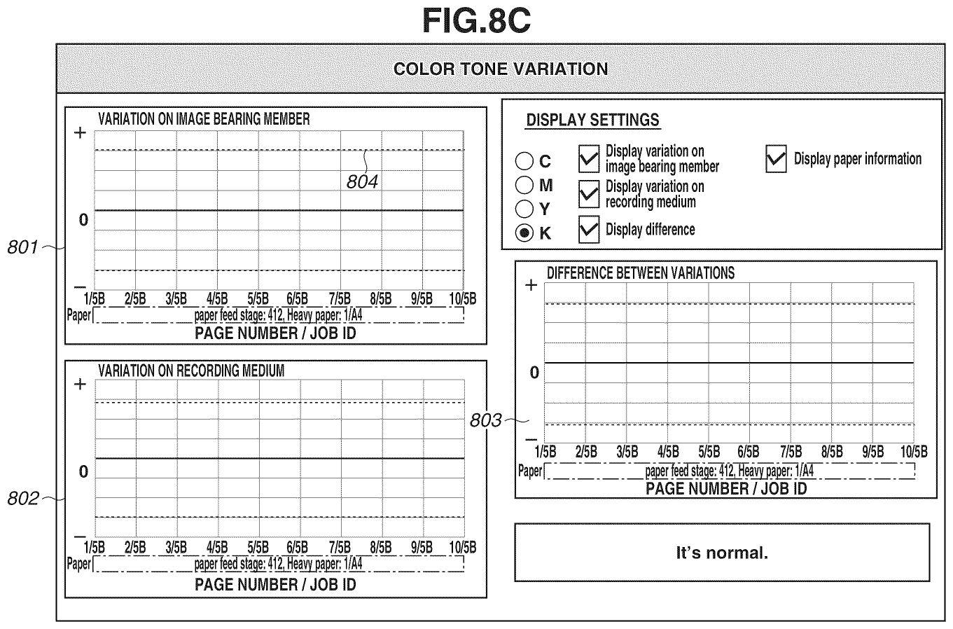

FIG. 8A is a schematic diagram of a screen for displaying the variation data. The details of the screen are described below with regard to step S610 described below.

Upon displaying the past variation data on the UI display unit 215, the CPU 212 advances the processing to step S603.

In step S603, the CPU 206 controls the print unit 203 to form toner images corresponding to the input image data and the color tone acquisition patch 501 on the photosensitive member and then transfer the toner images to the intermediate transfer belt 308. After causing the toner images transferred to the intermediate transfer belt 308 to be conveyed to the position of the density sensor 310 according to the revolution of the intermediate transfer belt 308, the CPU 206 advances the processing to step S604.

In step S604, the CPU 206 controls the density sensor 310 to acquire luminance values of the color tone acquisition patch 501. The CPU 206 then retains the acquired luminance values in the memory 207. Upon the completion of acquisition of the luminance values, the CPU 206 advances the processing to step S605.

In step S605, the CPU 206 controls the print unit 203 to convey the toner images (501 and 502) and then form (print) the toner images as a color image on a recording medium. After forming the color image on the recording medium and then conveying the recording medium to a position at which color tones are able to be read by the image reading unit 331, the CPU 206 advances the processing to step S606. Processing operations in step S606 and subsequent steps are performed by the image inspection unit 109.

In step S606, the CPU 212 controls the image reading unit 331 to acquire RGB values of the color tone acquisition patch 501. The CPU 212 then retains the acquired RGB values in the memory 213. After completing the acquisition of RGB values on the recording medium by the image reading unit 331, the CPU 212 advances the processing to step S607.

In step S607, the CPU 212 acquires the luminance value detected on the intermediate transfer belt 308 by the density sensor 310, which is currently retained in the memory 207 of the printing unit 107, and converts the acquired luminance value into a toner amount. Next, the CPU 212 calculates a variation between the toner amount obtained by conversion and a toner amount serving as a target (a target toner amount T_{50%}) described below. Additionally, the CPU 212 compares the calculated variation in toner amount and a variation criterion value Tₜₕ with each other and thus determines whether the variation in toner amount on the intermediate transfer belt 308 exceeds a criterion value.

First, conversion from a luminance value into a toner amount which is performed by the CPU 212 is described. The CPU 212 performs conversion from a luminance value into a toner amount with use of a known one-dimensional look-up table (LUT). In the first exemplary embodiment, a one-dimensional LUT representing a relationship between luminance values and toner amounts is preliminarily retained in the HDD unit 214 for each toner color, and the CPU 212 refers to the retained one-dimensional LUT to perform conversion processing.

An example of the one-dimensional LUT is shown in Table 1. Table 1 shows an example for black (K) toner with both an input and an output configured with 8 bits. The one-dimensional LUT retains output values with respect to input values taken at regular intervals. In a case where an intermediate value which is not retained in the one-dimensional LUT has been given as an input value, the CPU 212 outputs an output value based on known interpolation arithmetic processing.

A test patch in which a patch with a toner amount varied in various values has been recorded is preliminarily measured by a weight scale. The measured result is normalized into 8 bits in such a manner that 0.50 [mg/cm²] becomes “255”, and is preliminarily stored in the HDD unit 214.

TABLE 1

| Input (luminance value) | Output (toner amount) |
|---|---|
| 0 | 0 |
| 32 | 10 |
| 64 | 24 |
| 96 | 40 |
| 128 | 75 |
| 160 | 100 |
| 192 | 140 |
| 224 | 200 |
| 255 | 255 |

Next, an example of calculating a variation between the toner amount obtained by conversion and a toner amount serving as a target (a target toner amount T_{50%}) is described. The CPU 212 obtains the variation based on a difference between a toner amount T_{ITB} calculated from the luminance value and the target toner amount T_{50%}. Lastly, the CPU 212 compares the calculated variation in toner amount and the variation criterion value Tₜₕ with each other, and thus determines the presence or absence of a variation. In a case where the absolute value of the variation exceeds the variation criterion value Tₜₕ, the CPU 212 determines that there is a variation which exceeds the criterion.

Then, the CPU 212 implements the following determination formulae (1) with respect to the toner amount T_{ITB} calculated from the luminance value, the target toner amount T_{50%}, and the variation criterion value Tₜₕ, and thus determines the presence or absence of a variation which exceeds a criterion on the image bearing member. The CPU 212 sets, as a determination result R_{ITB} on the image bearing member, any one of three values, i.e., “1” in a case where the density is increasing with respect to the target, “−1” in a case where the density is decreasing with respect to the target, and “0” in a case where the variation is less than or equal to the criterion.

The determination result R_{ITB} is obtained for each toner color in a similar determination manner, and is, therefore, omitted from description.

$$If {T}_{50 \%} - {T}_{ITB} < 0 and {T}_{th} < \vert {T}_{50 \%} - {T}_{ITB} \vert , {R}_{ITB} = 1 , \qquad [ Determination formulae ( l ) ]$$

$$i f {T}_{50 \%} - {T}_{ITB} > 0 and {T}_{th} < \vert {T}_{50 \%} - {T}_{ITB} \vert , {R}_{ITB} = - 1 , and$$

$$in cases other than the above , {R}_{ITB} = 0.$$

After completing calculation of the determination result R_{ITB} and storing the calculated determination result R_{ITB} in the memory 213, the CPU 212 advances the processing to step S608. Next, step S608 for performing calculation of color tone variation information (a difference between the target value and the acquired toner amount for each page) on the recording medium 503 is described. In step S608, the CPU 212 acquires RGB values retained in the memory 213 and converts the RGB values into a toner amount. Next, the CPU 212 calculates a variation between the toner amount obtained by conversion and a toner amount serving as a target (target toner amount T_{50%}). Additionally, the CPU 212 compares the calculated variation in toner amount and the variation criterion value Tₜₕ with each other, and thus determines whether the variation in toner amount on the recording medium 503 exceeds the criterion value.

First, conversion from RGB values into a toner amount is described. Conversion from RGB values into a toner amount is performed with use of a known three-dimensional LUT designed based on a relationship between RGB values acquired by the image reading unit 331 and a toner amount. In the first exemplary embodiment, a three-dimensional LUT representing a relationship between RGB values and a toner amount is preliminarily retained in the HDD unit 214, and the CPU 212 refers to the three-dimensional LUT and thus performs conversion processing. Table 2 shows an example of the three-dimensional LUT.

Table 2 shows an example for black (K) toner with both an input and an output configured with 8 bits. The three-dimensional LUT retains output values with respect to input values taken at regular intervals. In a case where an intermediate value which is not retained in the three-dimensional LUT has been given as an input value, the CPU 212 outputs an output value based on known interpolation arithmetic processing. With regard to the three-dimensional LUT, a toner amount, which is the weight of an unfixed toner image on a standard recording medium 503 assumed to be used by the printing unit 107 on which a patch with a toner amount varied in various values has been recorded, is preliminarily measured by a weight scale. As with the color tone variation information in the image bearing member 308, the measured result is normalized into 8 bits in such a manner that 0.50 [mg/cm²] becomes “255”, and is preliminarily stored in the HDD unit 214. The relationship which is retained in the three-dimensional LUT varies depending on the grammage or surface property of a sheet of paper which is used as the recording medium 503, and is, therefore, from a more suitable viewpoint, desirable to be able to be calibrated based on the recording medium 503 used by the user, as discussed in Japanese Patent Application Laid-Open No. 2007-272112.

Furthermore, while, in the first exemplary embodiment, an example of calculating a toner amount with use of all of the RGB values has been described, the first exemplary embodiment is not limited to such example. As long as it is a method of calculating a toner amount from RGB values, for example, a method of calculating a toner amount from a signal value which has a complementary color relationship with a toner color can be employed.

TABLE 2

| Input (RGB values) | | | |
|---|---|---|---|
| R | G | B | Output (toner amount) |
| 0 | 0 | 0 | 255 |
| 0 | 0 | 32 | 253 |
| 0 | 0 | 64 | 250 |
| . | . | . | . |
| . | . | . | . |
| . | . | . | . |
| 0 | 0 | 255 | 200 |
| 0 | 32 | 0 | 251 |
| 0 | 32 | 32 | 245 |
| . | . | . | . |
| . | . | . | . |
| . | . | . | . |
| 255 | 255 | 255 | 0 |

Next, an example of calculating a variation between the toner amount obtained by conversion and a toner amount serving as a target (target toner amount T_{50%}) is described. The CPU 212 obtains the variation based on a difference between a toner amount Tₚₐₚₑᵣ calculated from the RGB values and the target toner amount T_{50%}. Lastly, the CPU 212 compares the calculated variation in toner amount and the variation criterion value Tₜₕ with each other, and thus determines the presence or absence of a variation. In a case where the absolute value of the variation exceeds the variation criterion value Tₜₕ, the CPU 212 determines that there is a variation which exceeds a criterion. The CPU 212 implements the following determination formulae (2) with respect to the toner amount Tₚₐₚₑᵣ calculated from the RGB values, the target toner amount T_{50%}, and the variation criterion value Tₜₕ, and thus determines the presence or absence of a variation which exceeds a criterion value on the recording medium 503. The CPU 212 sets, as a determination result Rₚₐₚₑᵣ on the recording medium, any one of three values, i.e., “1” in a case where the density is increasing with respect to the target, “−1” in a case where the density is decreasing with respect to the target, and “0” in a case where the variation is less than or equal to the criterion value. The determination result Rₚₐₚₑᵣ is obtained for each toner color in a similar determination manner, and is, therefore, omitted from description.

$$If {T}_{50 \%} - {T}_{paper} < 0 and {T}_{th} < \vert {T}_{50 \%} - {T}_{paper} \vert , {R}_{paper} = 1 , \qquad [ Determination formulae ( 2 ) ]$$

$$i f {T}_{50 \%} - {T}_{paper} > 0 and {T}_{th} < \vert {T}_{50 \%} - {T}_{paper} \vert , {R}_{paper} = - 1 , and$$

$$in cases other than the above , {R}_{paper} = 0.$$

After completing calculation of the determination result Rₚₐₚₑᵣ and storing the calculated determination result Rₚₐₚₑᵣ in the memory 213, the CPU 212 advances the processing to step S609. Next, step S609 for calculating a difference in toner amount between the respective printing processes and thus determining whether a variation which exceeds the criterion value is occurring between the respective printing processes is described.

In step S609, the CPU 212 compares the toner amount T_{ITB} calculated in step S606 and the toner amount Tₚₐₚₑᵣ calculated in step S607 with each other. In the first exemplary embodiment, the CPU 212 makes such a comparison and thus calculates a difference therebetween. The CPU 212 uses the following determination formulae (3) to determine whether the calculated difference exceeds the variation criterion value. The CPU 212 sets, as a determination result Raiff of the difference, any one of three values, i.e., “1” in a case where the density in the toner amount T_{ITB} is increasing with respect to the toner amount Tₚₐₚₑᵣ, “−1” in a case where the density in the toner amount T_{ITB} is decreasing with respect to the toner amount Tₚₐₚₑᵣ, and “0” in a case where the variation is less than or equal to the criterion value. The determination result R_{diff} is obtained for each toner color in a similar determination manner, and is, therefore, omitted from description.

$$If {T}_{ITB} - {T}_{paper} > 0 and {T}_{th} < \vert {T}_{ITB} - {T}_{paper} \vert = 1 , {R}_{diff} = 1 , \qquad [ Determination formulae ( 3 ) ]$$

$$if {T}_{ITB} - {T}_{paper} < 0 and {T}_{th} < \vert {T}_{ITB} - {T}_{paper} \vert , {R}_{diff} = - 1 , and$$

$$in cases other than the above , {R}_{diff} = 0.$$

After completing calculation of the determination result R_{diff} and storing the calculated determination result R_{diff} in the memory 213, the CPU 212 advances the processing to step S610.

In step S610, the CPU 212 controls the UI display unit 215 to notify the user of the determination result. FIGS. 8A, 8B, and 8C are schematic views of screens each of which is displayed on the UI display unit 215.

FIG. 8A illustrates a screen in an initial state before the start of a print job. The screen in an initial state displays variation data (color tone variation information) about the last five pages of a print job which is one job earlier. The variation data is displayed for each print page one by one, and a job identification (ID), a page number, and paper information included in print settings used in the print job are displayed. Furthermore, the job ID is a unique identification number for each print job for discriminating a print job. The paper information displays information about a paper feed stage storing sheets of paper, the size of paper, and the type of paper. While an example in which paper information is displayed as one of print settings to be displayed has been described, the first exemplary embodiment is not limited to such example. As long as it is any one of print settings which may cause a variation, for example, a screen condition used for a halftone (halftone processing), a resolution at which to perform RIP processing, or the orientation of printing can be displayed.

Switching between radio buttons in the display settings enables switching between colors to be displayed or changing variations to be displayed. FIG. 8A illustrates an example of showing a result obtained for black (K) toner serving as a display color and simultaneously displaying both color tone variation information on the image bearing member (intermediate transfer belt) 308 and color tone variation information on the recording medium 503. Furthermore, the above-mentioned display configuration is merely an example, and the first exemplary embodiment is not limited to such example. While an example in which a variation on the image bearing member and a variation on the recording medium are displayed in one screen has been described as a more favorable example, a configuration in which only one type of variation is displayed in a screen and an item to be displayed is switchable by the settings can be employed. Moreover, a configuration in which variations for a plurality of color toners are simultaneously displayed can also be employed. A configuration in which variations are juxtaposed for respective color toners or a configuration in which colors of points to be plotted are made changeable and are displayed in an overlapping manner can also be employed.

Additionally, not only an item which the user wants to cause to be displayed can be made changeable but also the graph size of each variation to be displayed or the layout of variations in each graph can be made freely changeable. A display region 801 is a display portion in which, with the target toner amount T_{50%} set to “0” serving as a criterion value, a relationship between the target toner amount T_{50%} and the toner amount T_{ITB} on the image bearing member is shown for each page. Similarly, a display region 802 shows a relationship between the target toner amount T_{50%} and the toner amount Tₚₐₚₑᵣ on the recording medium. A display region 803 shows a relationship between the target toner amount T_{50%} and a difference between the toner amount T_{ITB} on the image bearing member and the toner amount Tₚₐₚₑᵣ on the recording medium. In the display region 803, as the creation of a printed product by a print job subjected to a printing instruction progresses, variations are added for each print page.

FIG. 8B illustrates a behavior in which the number of printed pages in a print job subjected to a printing instruction has advanced to page 5.

Referring to FIG. 8B, plots are added in real time for each increment in the number of printed pages, thus enabling the user to become conscious of the presence or absence of a variation and make adjustments. Moreover, since variations in a plurality of jobs are shown side by side in a checkable manner, it is easy for the user to compare the presence or absence of a variation with switching timing of print jobs. For example, in a case where the presence or absence of a variation and switching timing of print jobs coincide with each other, it is suggested that variations are likely to be affected by changing of print settings such as those for paper or halftone.

Moreover, the criterion value 804 is a variation criterion value Tₜₕ and, based on a relationship between a criterion and a variation, it is possible to easily determine whether the variation is at a level requiring adjustments. In the first exemplary embodiment, additionally, as a more favorable example, an example of adding processing for automatically determining whether correction measures are required for the printing unit 107, based on variations in the respective printing processes and a difference between the variations, is described. Such determination processing corresponds to step S611 and step S612. After updating displaying of the screen in step S610, the CPU 212 advances the processing to step S611.

In step S611, the CPU 212 determines whether correction measures are required for the printing unit 107, based on the determination result R_{ITB} on the image bearing member, the determination result Rₚₐₚₑᵣ on the recording medium, and the determination result R_{diff} of the difference. The CPU 212 preliminarily retains, in the HDD unit 214, combinational information in which the presence or absence of correction measures has been recorded with respect to combinations of values of the determination results R_{ITB}, Rₚₐₚₑᵣ, and R_{diff}, and performs such determination by referring to the retained combinational information. Table 3 shown an example of the combinational information.

TABLE 3

| | Determination | Determination | | |
|---|---|---|---|---|
| | Result R_{ITB} on | Result Rₚₐₚₑᵣ | Determination | |
| | image bearing | on recording | Result R_{diff} | Correction |
| ID | member | medium | of difference | measures |
| 0 | 0 | 0 | 0 | None |
| | | | | (normal) |
| 1 | 1 | 1 | 0 | Gradation |
| | | | | correction |
| 2 | −1 | −1 | 0 | Gradation |
| | | | | correction |
| 3 | 0 | 1 | 1 | Secondary |
| | | | | transfer |
| | | | | voltage |
| | | | | adjustment |
| 4 | 0 | −1 | −1 | Secondary |
| | | | | transfer |
| | | | | voltage |
| | | | | adjustment |
| 5 | 1 | 0 | 1 | Secondary |
| | | | | transfer |
| | | | | voltage |
| | | | | adjustment |
| | | | | after |
| | | | | gradation |
| | | | | correction |
| 6 | −1 | 0 | −1 | Secondary |
| | | | | transfer |
| | | | | voltage |
| | | | | adjustment |
| | | | | after |
| | | | | gradation |
| | | | | correction |
| . | . | . | . | . |
| . | . | . | . | . |
| . | . | . | . | . |
| . | . | . | . | . |
| . | . | . | . | . |
| . | . | . | . | . |

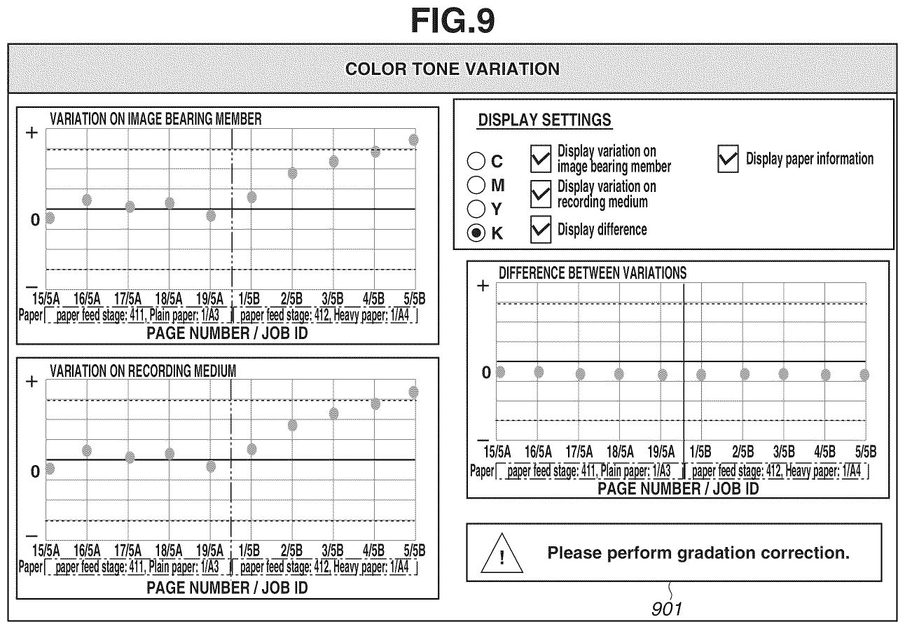

In a case where, as shown in the row “ID=1” in Table 3, there is a color tone variation in the determination result R_{ITB} on the image bearing member and a similar color tone variation is also occurring in the determination result Rₚₐₚₑᵣ on the recording medium, there is high likely to be a variation in the stage of a toner image on the intermediate transfer belt 308 serving as an image bearing member. Therefore, it is desirable that gradation correction processing for correcting a toner image on the intermediate transfer belt 308 be performed. In the above-mentioned case (YES in step S611), then in step S612, the CPU 212 controls the UI display unit 215 to instruct the user to perform gradation correction processing. FIG. 9 illustrates an example of a screen for issuing such an instruction to the user in the state of “ID=1” in Table 3. As shown in a displayed message 901, the UI display unit 215 displays a gradation correction instruction reacting to the variation along with an emphasis icon.

Moreover, in a case where, as shown in the row “ID=4” in Table 3, although there is no color tone variation in the determination result R_{ITB} on the image bearing member, a density decrease is occurring in the determination result Rₚₐₚₑᵣ on the recording medium, there is high likely to be a variation in the stage of a transfer process for a toner image from the intermediate transfer belt 308 to the recording medium. Therefore, it is desirable that secondary transfer voltage adjustment processing for adjusting a toner amount in the transfer process be performed.

In the above-mentioned case (YES in step S611), then in step S612, the CPU 212 controls the UI display unit 215 to instruct the user to perform secondary transfer voltage adjustment processing. For example, in a region corresponding to the displayed message 901 illustrated in FIG. 9, the UI display unit 215 displays a secondary transfer voltage adjustment instruction along with an emphasis icon. With regard to secondary transfer voltage adjustment, in one embodiment, it is often the case that readjustment becomes required due to a difference in the grammage of paper. Therefore, the user confirms a difference in paper for each print job and is thus able to easily check the presence or absence of a lack of adjustment.

Additionally, in a case where, as shown in the row “ID=5” in Table 3, although a color tone variation is occurring in the determination result R_{ITB} on the image bearing member, no color tone variation is occurring in the determination result Rₚₐₚₑᵣ on the recording medium, in one embodiment, it is highly likely that adjustment is required in both a process for forming a toner image and a process for transferring a toner image.

In the above-mentioned example, in one embodiment, after correcting, by gradation correction, the formation of a toner image, which is on the upstream side of a printing process, adjustment of a process for transferring a toner image by secondary transfer voltage adjustment is performed.

In step S612, the CPU 212 controls the UI display unit 215 to notify the user, as an instruction, that both gradation correction processing and secondary transfer voltage adjustment processing are required and that gradation correction processing be performed prior to secondary transfer voltage adjustment processing. Furthermore, the above-mentioned instruction about correction measures against color tone variations is merely an example, and the beneficial effect of the aspect of the embodiments is not limited to the above-mentioned example. For example, a configuration in which, in a case where, even if gradation correction and secondary transfer voltage adjustment are performed, the variation does not decrease, the CPU 212 performs adjustment in a process for fixing a toner image to the recording medium 503 can be employed. Furthermore, in the fixing process, it is possible to stabilize a color tone by adjusting the temperature of a fixing member (not illustrated) or a pressure for pressing the fixing member to the recording medium 503.

While, in the first exemplary embodiment, an example of displaying an adjustment instruction based on the determination result has been described, the beneficial effect of the disclosure is not limited to such example. In one embodiment, the CPU 212 only needs to be able to perform measurements for causing a variation occurring in the printing unit 107 to decrease, based on the determination result. For example, a configuration in which, in a case where the variation has exceeded the criterion value, the CPU 212 stops print processing in the printing unit 107 and automatically performs adjustment measures can be employed. Additionally, items to be presented are not limited to only types of adjustment measures. An adjustment value for causing the variation to decrease can be presented based on the variation.

In step S613, the CPU 212 stores variation data for all of the pages corresponding to a print job subjected to a printing instruction in the HDD unit 214. Upon the completion of storage in the HDD unit 214, the CPU 212 ends the determination processing in the image inspection unit 109.

As described above, the image forming apparatus 101 includes a printing unit including a plurality of image adjustment units and an acquisition unit configured to acquire, in addition to a color tone on the recording medium 503, a color tone on the intermediate transfer belt 308 in the middle of print processing, and thus acquires color tones in a plurality of processes. Additionally, the image forming apparatus 101 calculates variations based on the two color tones, and displays a color tone variation on the intermediate transfer belt 308 and a color tone variation on the recording medium 503 on a user interface (UI). The image forming apparatus 101 displays color tone variations on the intermediate transfer belt 308 and color tone variations on the recording medium 503 in a plurality of print jobs and compares the variations with each other, thus enabling the user to recognize in which printing process or printing setting a color tone variation is occurring.

### Modification Example of First Exemplary Embodiment

Furthermore, while, in the first exemplary embodiment, an example in which, in an initial state, a variation in a print job which is one job earlier is displayed has been described, the initial state is not limited to such example. In a case where the user determines that the variation does not have continuity from a print job which is one job earlier, such as a case where print jobs differ in the date and time of printing or a case where a print job is executed immediately after calibration, a state in which no variations are displayed as illustrated in FIG. 8C can be set as an initial state. In such a case, in a setting screen for color tone variation detection, an item for causing the user to select whether to display variations having occurred in past jobs (previously executed jobs), such as a check box 701b illustrated in FIG. 7B, is provided.

Furthermore, while, in the first exemplary embodiment, an example in which the intermediate transfer belt 308 is used as an image bearing member has been described, the image bearing member in the first exemplary embodiment is not limited to such example. Additionally, a toner image in a printing process different from the printing process for the recording medium can be used, and a density sensor can be arranged at a position facing the photosensitive drum to measure a color tone with the photosensitive drum made to serve as an image bearing member.

Furthermore, while, in the first exemplary embodiment, an example of acquiring color tones in a plurality of printing processes and displaying variations of the color tones has been described, the variations to be displayed are not limited to color tones. In the first exemplary embodiment, examples of variation factors which affect color tones include a temperature and humidity inside the printing unit 107. In a case where color tones vary due to the influence of the temperature and humidity, even if measures such as the above-mentioned gradation correction have been taken, there occurs no improvement. In the above-mentioned case, a thermohygrometer is arranged inside the printing unit 107 to perform measurements in real time, and set the measured result as a determination criterion in step S611. Table 4 shows an example of combinational information obtained by adding a column for the temperature and humidity to the combinational information shown in Table 3. Table 4 differs from Table 3 in that the column for the temperature and humidity is added as a determination criterion. In a case where, as shown in the row “ID=7” in Table 4, there is a variation in the temperature and humidity and variations are occurring in each of the printing processes, the CPU 212 controls the UI display unit 215 to instruct the user to perform adjustments of the indoor temperature and humidity.

TABLE 4

| | Determi- | | | | |
|---|---|---|---|---|---|
| | nation | Determi- | | | |
| | Result | nation | Determi- | | |
| | R_{ITB} on | Result | nation | Temper- | |
| | image | Rₚₐₚₑᵣ on | Result | ature | |
| | bearing | recording | R_{diff} of | and | Correction |
| ID | member | medium | difference | humidity | measures |
| 0 | 0 | 0 | 0 | Variation | None |
| | | | | absent | (normal) |
| 1 | 1 | 1 | 0 | Variation | Gradation |
| | | | | absent | correction |
| 2 | −1 | −1 | 0 | Variation | Gradation |
| | | | | absent | correction |
| 3 | 0 | 1 | 1 | Variation | Secondary |
| | | | | absent | transfer |
| | | | | | voltage |
| | | | | | adjustment |
| 4 | 0 | −1 | −1 | Variation | Secondary |
| | | | | absent | transfer |
| | | | | | voltage |
| | | | | | adjustment |
| 5 | 1 | 0 | 1 | Variation | Secondary |
| | | | | absent | transfer |
| | | | | | voltage |
| | | | | | adjustment |
| | | | | | after |
| | | | | | gradation |
| | | | | | correction |
| 6 | −1 | 0 | −1 | Variation | Secondary |
| | | | | absent | transfer |
| | | | | | voltage |
| | | | | | adjustment |
| | | | | | after |
| | | | | | gradation |
| | | | | | correction |
| 7 | 1/−1 | 1/−1 | 1/−1 | Variation | Instruction |
| | | | | present | for |
| | | | | | adjusting |
| | | | | | indoor |
| | | | | | temperature |
| | | | | | and |
| | | | | | humidity |
| . | . | . | . | | . |
| . | . | . | . | | . |
| . | . | . | . | | . |
| . | . | . | . | | . |
| . | . | . | . | | . |
| . | . | . | . | | . |

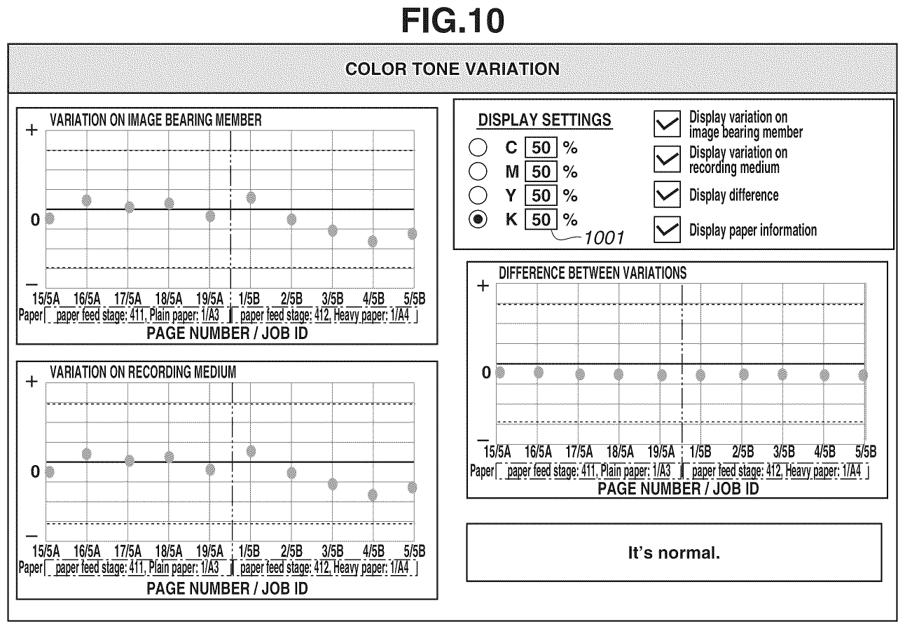

Furthermore, while, in the first exemplary embodiment, an example in which only a patch with an area ratio of 50% is arranged and a variation in a specific density is checked has been described, the density in which to check a variation is not limited to such example. In one embodiment, patches with a plurality of area ratios are arranged to acquire variations. For example, ten patterns can be acquired with 10% increments in between 10% and 100% and the densities in which to check variations can be switched and displayed as indicated by display settings 1001 illustrated in FIG. 10.

Furthermore, while, in the first exemplary embodiment, an example of displaying variations in a print job in real time has been described, more favorably, it is desirable to employ a configuration capable of checking where there were no problems in a past variation result. For example, variations which are being displayed in step S610 can be stored in not only the memory 213 but also the HDD unit 214 and a function of displaying past variations on the UI display unit 215 in response to a designation received from the user can be provided.

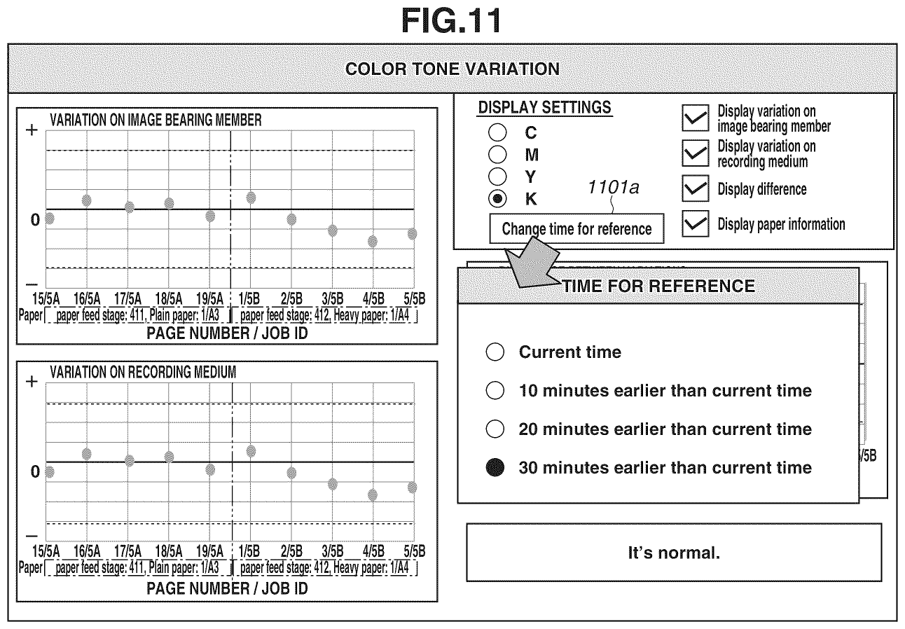

FIG. 11 illustrates an example of a screen which is displayed when the user designates information which the user wants to check. A button for changing reference information such as a button 1101a illustrated in FIG. 11 is provided, and, in a case where the user has pressed the button 1101a, the CPU 212 can accept the designation of information in which the user wants to refer to variations and display variations in the designated information on the UI display unit 215. For example, while, in FIG. 11, a method of designating relative time based on current time is illustrated, for example, a method capable of designating the absolute date and time such as a calendar or a method of designating the ID of a print job can be employed.

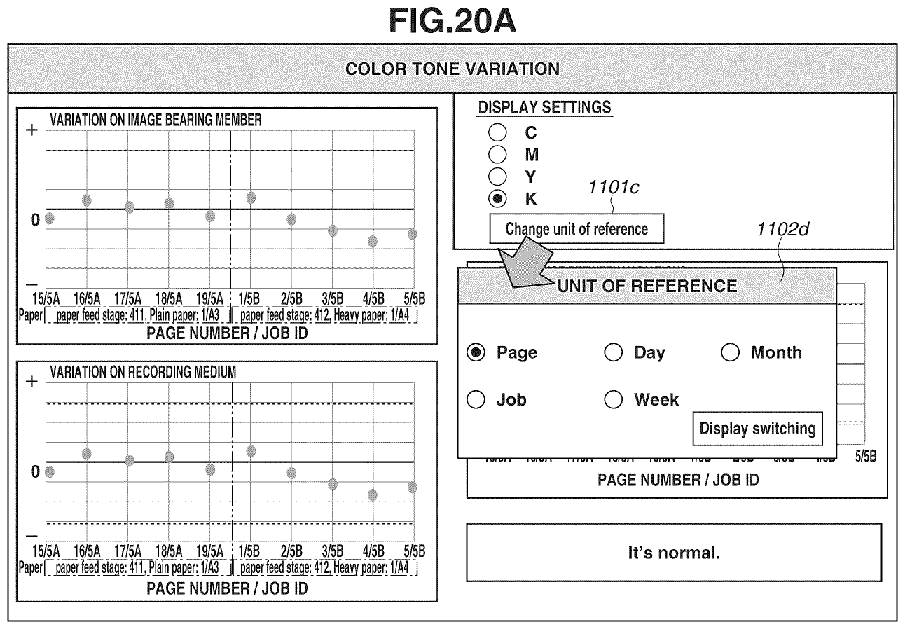

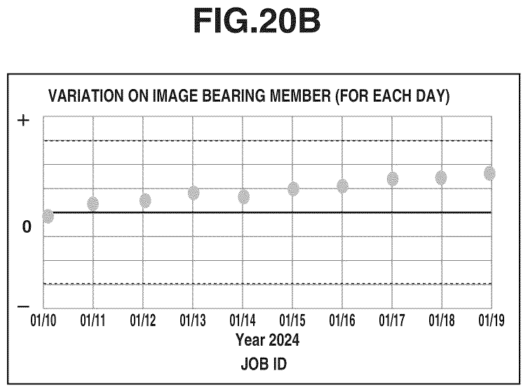

Furthermore, while, in the first exemplary embodiment, an example of displaying variations in units of print pages has been described, the units in which to display variations are not limited to such example. For example, reference units for variations can be made switchable with use of, for example, a button 1101c illustrated in FIG. 20A. In response to the button 1101c being pressed, a pop-up 1102d is displayed, so that reference units in which to display variations become switchable. In a case where each reference unit is composed of a plurality of pages (other than the unit of page), the average value of variations in respective pages included in the reference unit is calculated and the calculated average value is displayed as a representative value. More favorably, in one embodiment, with respect to not only the reference unit but also other than the average value, methods of calculating respective different representative values, such as a median value, a maximum value, and a minimum value, are made switchable. FIG. 20B illustrates a display example in which representative values of variations on the image bearing member for the respective dates on which printing was performed are plotted. The user is able to confirm that, in a case where, as in the display example illustrated in FIG. 20B, variations are within the criterion value range but are gradually shifting to outside the criterion value range, the image bearing member concerned has deteriorated and, therefore, has to be replaced with a new one. As mentioned above, in the case of checking a degree of deterioration of parts included in the apparatus, it is necessary to check variations in a plurality of printing processes in a longer time than the unit of page.

Furthermore, while, in the first exemplary embodiment, an example of acquiring color tones from patches made from the same toner image on the image bearing member and on the recording medium has been described, the first exemplary embodiment is not limited to such example. In a case where the main scanning position available for performing reading differs between the density sensor 310 and the image reading unit 331, the image forming apparatus 101 can acquire color tones from different patches which have been printed under the same printing condition.

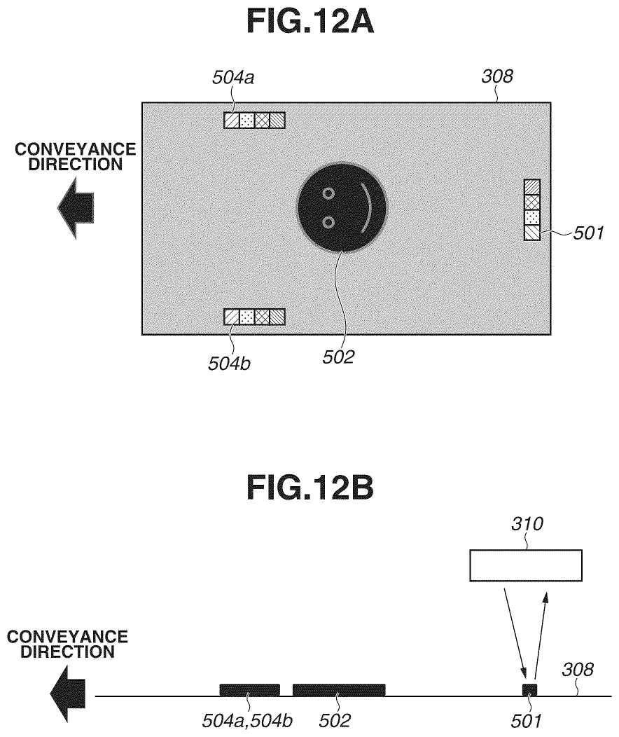

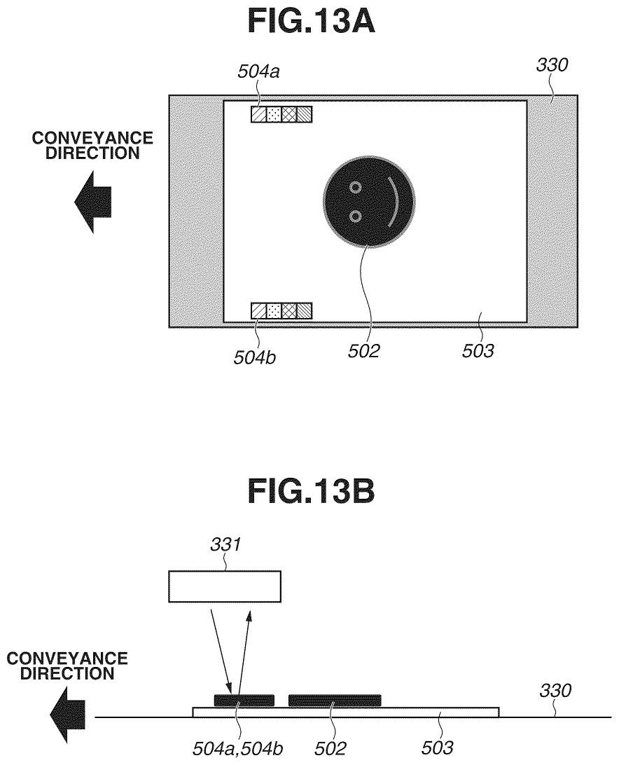

FIGS. 12A and 12B and FIGS. 13A and 13B illustrate an example of acquiring color tones from different patches. FIGS. 12A and 12B illustrate such an example which is performed under the same condition as that in the example illustrated in FIGS. 4A and 4B, and FIGS. 13A and 13B illustrate such an example which is performed under the same condition as that in the example illustrated in FIGS. 5A and 5B. For example, in a case where the density sensor 310 is able to perform measurement near the middle of the image bearing member and the image reading unit 331 is able to perform measurement only at positions corresponding to the both end portions of the conveyance path, separate patches for acquiring color tones, such as a patch 501 and a pair of patches 504a and 504b illustrated in FIGS. 12A and 12B, can be used. The patch 501 is used to acquire a color tone on the image bearing member, and the pair of patches 504a and 504b is used to acquire a color tone on the recording medium 503. In the above-mentioned case, as illustrated in FIGS. 13A and 13B, it is desirable not to form, on the recording medium 503, a patch for acquiring a color tone only on the image bearing member.

Furthermore, while, in the first exemplary embodiment, an example in which the image forming apparatus 101 includes a plurality of display units (the UI display units 202 and 215) and performs settings of a print job on the UI display unit 202 and displaying of variations on the UI display unit 215 has been described, a combination of items to be displayed and display units is not limited to such example. For example, in a case where there is no display unit other than the UI display unit 202, all of the items can be displayed on such a single display unit.

Acquisition processing for color tones according to a second exemplary embodiment of the disclosure is described. In the above-described first exemplary embodiment, an example of forming the patch 501 for acquiring a color tone on the recording medium 503 has been described. However, the beneficial effect of the aspect of the embodiments is not limited to such example. For example, there is a case where the proportion of the toner image 502 caused by the input image data on the recording medium 503 is large and, therefore, the patch 501 is unable to be arranged on the recording medium 503. In such a case, a color tone is acquired from the toner image caused by the input image data and check variations.

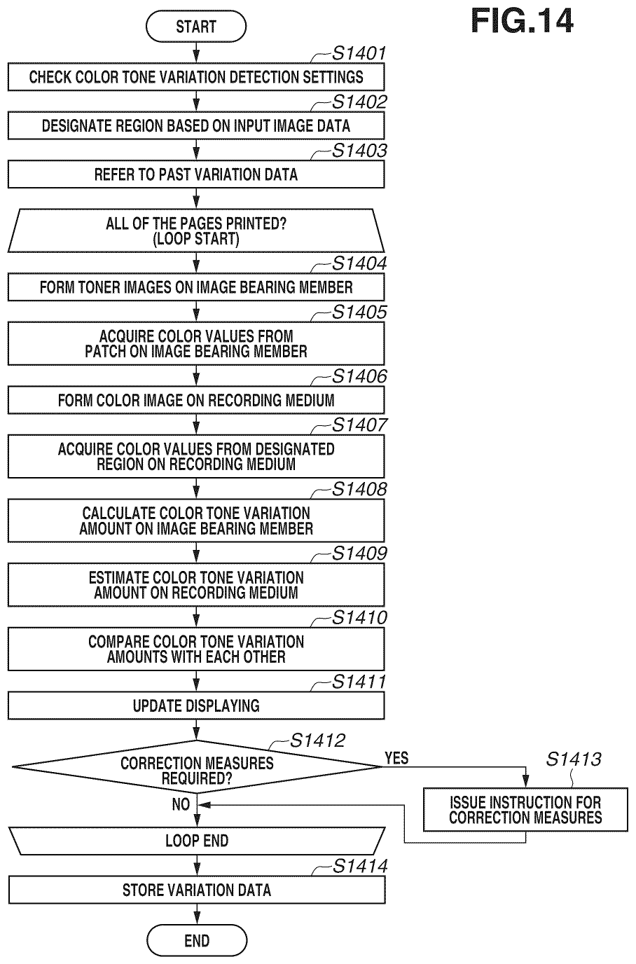

Processing which is performed in the image inspection unit 109 according to the second exemplary embodiment is described with reference to FIG. 14. FIG. 14 is a flowchart illustrating a processing procedure for causing the image inspection unit 109 to calculate variations of color tones during a print job in progress which is executed by the printing unit 107 and displaying a result of the calculation, as with the first exemplary embodiment. The flowchart in the second exemplary embodiment differs from the flowchart in the first exemplary embodiment in two steps, i.e., step S1402 and step S1409. In step S1402, the user designates a position at which to acquire a color tone on the recording medium 503 from the input image data. In step S1409, the CPU 212 estimates, from the acquired color tone, information which is comparable to a color tone on the image bearing member. Furthermore, a printing system (image forming system) and a functional configuration thereof according to the second exemplary embodiment are similar to those in the first exemplary embodiment, and are, therefore, omitted from description here. Processing operations in step S1402 and step S1409, which are different from those in the first exemplary embodiment, are described. The processing operation in step S1402 is performed by the CPU 206 of the printing unit 107, and the processing operation in step S1409 is performed by the CPU 212 of the image inspection unit 109.

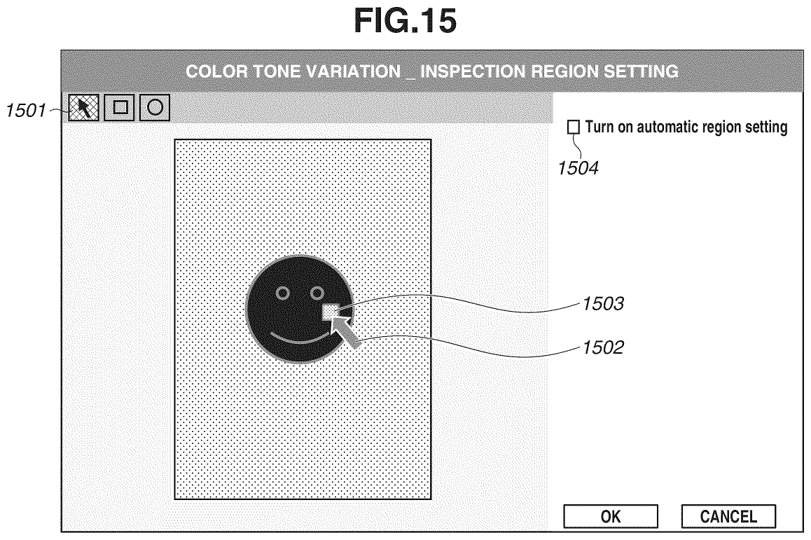

In step S1402, the CPU 206 accepts an instruction for a position at which to acquire a color tone on the recording medium 503, based on an instruction issued by the user on the UI display unit 202. FIG. 15 is a schematic view of a screen for accepting an instruction from the user. In response to settings of color tone variation detection being performed on the setting screens illustrated in FIGS. 7A and 7B, the CPU 206 controls the UI display unit 202 to display a screen illustrated in FIG. 15. As illustrated in FIG. 15, the CPU 206 causes the image data input by the user to be previewed and allows the user to designate a position at which to acquire a color tone. The user selects a designation method for the position from a task bar 1501. For example, the user is allowed to select a designation method, such as designating the center location of a measurement position by a cursor, designating the center location of a measurement position by a rectangle, or designating the center location of a measurement position by a circle. FIG. 15 illustrates an example of designating the center location of a measurement position by a cursor 1502. The user moves the cursor 1502 on the preview screen and thus designates the position. In response to receiving an instruction from the user, the CPU 206 notifies the user of the position by a rectangle 1503 which is highlighted.

After confirming pressing of an OK button by the user, the CPU 206 stores, in the memory 207, the last designated position as a position at which to measure a color tone on the recording medium 503, and then advances the processing to step S1403. Furthermore, while, in the second exemplary embodiment, an example in which the user designates only one location has been described, the second exemplary embodiment is not limited to such example. Acquiring color tones at a plurality of locations enables acquiring stable color tone variations. It is desirable to set the upper limit of the number of locations based on the number of regions at which the image reading unit 331 is able to acquire color tones during the conveyance of the recording medium 503. Moreover, while an example in which the user designates the position has been described, the designation method for an acquisition region is not limited to such example. A configuration in which the CPU 206 automatically selects a region based on the input image data, such as a button 1504 illustrated in FIG. 15, can be provided. It is desirable that the acquisition region be subjected to the same printing condition (combination of toners and area ratio) as that for the patch 501 for acquiring a color tone on the image bearing member. For example, in one embodiment, a configuration of automatically selecting a region close to a printing condition included in the patch 501 only needs to be provided.

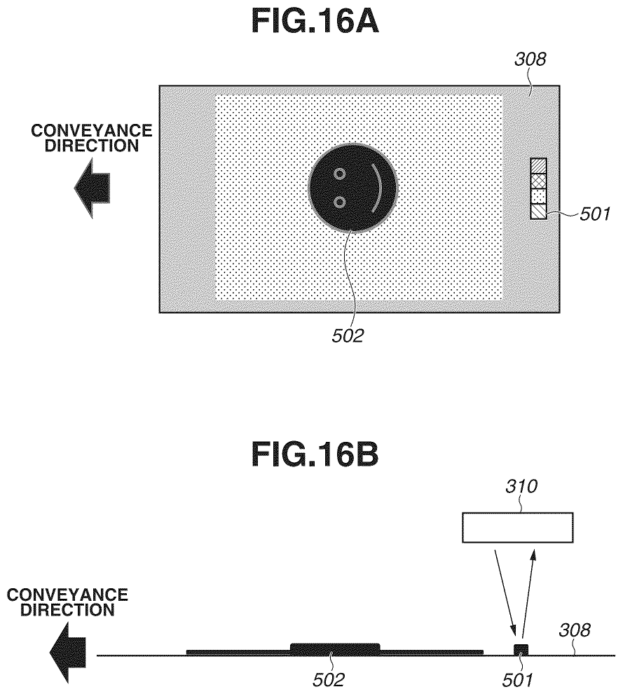

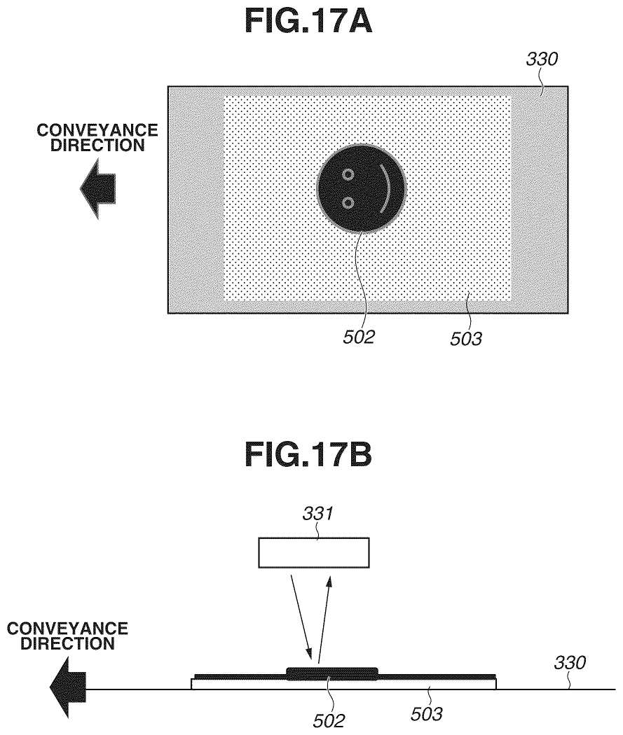

In step S1409, based on the acquired RGB values, the image inspection unit 109 estimates a toner amount on the recording medium 503 in the same printing condition as that for the patch 501 for acquiring a color tone on the image bearing member. FIGS. 16A and 16B and FIGS. 17A and 17B are schematic views illustrating examples of behaviors of acquiring color tones in the second exemplary embodiment. FIGS. 16A and 16B illustrate such an example which is performed under the same condition as that in the example illustrated in FIGS. 4A and 4B, and FIGS. 17A and 17B illustrate such an example which is performed under the same condition as that in the example illustrated in FIGS. 5A and 5B. In the second exemplary embodiment, the patch 501 illustrated in FIGS. 16A and 16B is formed to acquire a color tone on the image bearing member. As illustrated in FIG. 17B, the color tone on the recording medium 503 is a color tone acquired at a position designated by the user in step S1402. As illustrated in FIGS. 17A and 17B, in the second exemplary embodiment, a patch for acquiring a color tone on the image bearing member is not formed on the recording medium 503.

In step S1409, because of acquiring a color tone in a mixed color region composed of a plurality of color toners, unlike step S608, the CPU 212 uses color conversion measures different from those in step S608 to calculate a toner amount. First, the CPU 212 converts RGB values into a device-independent L*a*b* color space. Additionally, the CPU 212 converts device-independent L*a*b* into a toner amount T_{CMYK} representing a device-dependent toner amount. The CPU 212 performs each color conversion with use of a three-dimensional LUT similar to the above-mentioned form. Conversion from L*a*b* into the toner amount T_{CMYK} is performed with use of the same three-dimensional LUT as a conversion method used for converting input image data into a toner image. Calculating a toner image by once converting RGB values into a device-independent color space and performing conversion similar to that used for input image data enables calculating a toner image even from a mixed color region with a high degree of accuracy. Next, the CPU 212 estimates, from the calculated toner amount T_{CMYK}, a toner amount Tₒᵤₜ on the image bearing member 308 which is based on an engine state.

The engine state in the second exemplary embodiment represents a relationship between a toner amount Tᵢₙ to be input and a toner amount Tₒᵤₜ actually recorded on the recording medium 503. The engine state changes depending on a temperature and humidity inside the main body or replacement timing of a toner cartridge. The CPU 212 retains an assumed plurality of engine states, searches for an engine state closest to the toner amount T_{CMYK} calculated with use of a three-dimensional LUT, and determines that the found engine state is a current engine state. The CPU 212 performs estimation of the engine state for each toner color, and, in the following description, such estimation is described with a toner amount Tₖ of black (K) toner used as an example.

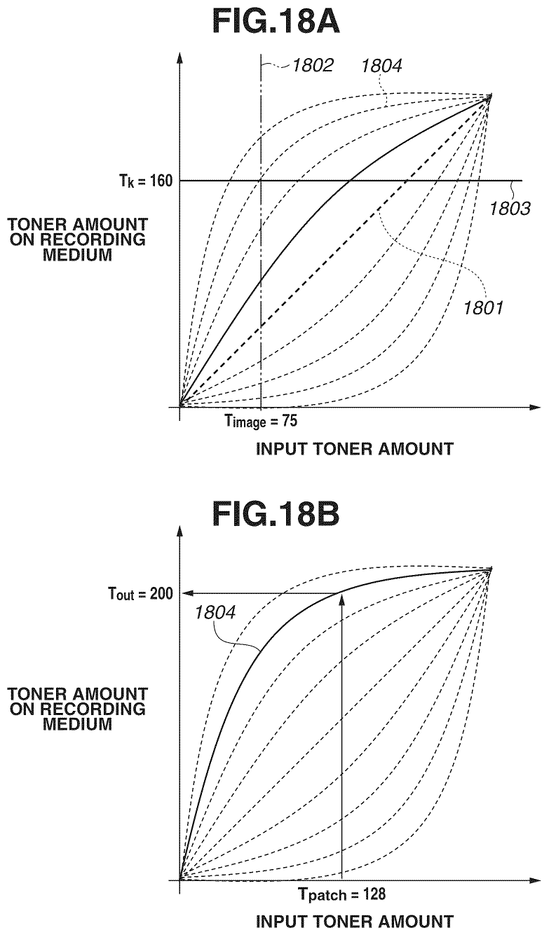

First, an example of determining the engine state is described. FIG. 18A is a diagram schematically illustrating a previously retained plurality of engine states. If the engine is in a state close to the criterion, as indicated by a dashed line 1801, the toner amount Tᵢₙ that is based on the input image data and the toner amount Tₒᵤₜ on the recording medium 503 enter into a linear relationship. From among the above-mentioned engine states, the CPU 212 searches for an engine state close to the relationship between an input toner amount T_{image} in a region designated by the user in the input image data and the toner amount Tₖ calculated with use of the three-dimensional LUT. With regard to such searching, the CPU 212 searches for an engine state which takes a value closest to the value of the toner amount Tₖ acquired by the image reading unit 331 on the recording medium 503 in an axis 1802 of the input toner amount T_{image}. In FIG. 18A, an example in which, while a control operation of forming a toner image with the input toner amount T_{image}=75 on the recording medium 503 is performed, the toner amount on the recording medium 503 acquired by the image reading unit 331 is “toner amount Tₖ=160” is schematically illustrated. The CPU 212 determines that an engine state 1804 which is closest to an intersection point between “input toner amount T_{image}=75” and “toner amount Tₖ=160” on the axis 1802 is the current engine state.

Next, based on the found engine state, the CPU 212 estimates a toner amount Tₒᵤₜ on the recording medium 503 in an area ratio of 50% (toner amount T_{patch}=128), which is the same printing condition as that for the patch toner image. FIG. 18B illustrates an example of such estimation. The CPU 212 calculates the toner amount Tₒᵤₜ on the recording medium 503 corresponding to the toner amount T_{patch}=128 in the engine state 1804, and sets the calculated toner amount Tₒᵤₜ as an estimated value. In the example illustrated in FIG. 18B, the CPU 212 determines that the value corresponding to the toner amount T_{patch}=128 in the engine state 1804 is “toner amount Tₒᵤₜ=200”. The CPU 212 performs estimation of the toner amount Tₒᵤₜ for each toner color, retains the estimated values for all of the toner colors in the memory 213, and then advances the processing to step S1410. Processing operations in step S1410 and subsequent steps are similar to those in the first exemplary embodiment and are, therefore, omitted from description here. As with the first exemplary embodiment, processing operations in step S1404 to step S1413 are processing operations which are performed in units of pages. In a case where the print job is data configured with a plurality of pages, step S1404 to step S1413 are repeatedly performed for every page and are repeated until printing for all of the pages included in the print job is complete. Upon the completion of printing, lastly, as with the first exemplary embodiment, the CPU 212 stores variation data for all of the pages corresponding to a print job subjected to a printing instruction in the HDD unit 214.

As described above, an example in which, in a case where the proportion of the toner image 502 caused by input image data on the recording medium 503 is large, the CPU 212 acquires a color tone on the recording medium 503 from a toner image corresponding to the input image data has been described. Thus, the CPU 212 estimates, from an input-image toner image formed in a printing condition different from that for the patch toner image on the image bearing member 308, a color tone in the same printing condition as that for the patch toner image. With the above-mentioned estimation measures being added, even in a case where the proportion of the toner image 502 caused by input image data on the recording medium 503 is large, the CPU 212 displays a color tone variation on the image bearing member 308 and a color tone variation on the recording medium 503 and thus enables the user to compare the variations with each other. As a result, the user becomes able to compare variations in a plurality of print jobs with each other and recognize in which printing process and in which printing setting a color tone variation is occurring.

Furthermore, in the second exemplary embodiment, an example of estimating, from an input-image toner image formed in a printing condition different from that for a patch toner image, a color tone in the same printing condition as that for the patch toner image has been described. However, the advantageous effect of the aspect of the embodiments is not limited to such example. The printing condition for forming a patch toner image can be changed based on a printing condition for a region selected by the user. In the case of such example, in step S1402, upon receiving a region designation from the user, the CPU 206 changes the printing condition for forming a patch toner image in such a manner that a printing condition for the selected region and a printing condition for forming a patch toner image in step S1404 coincide with each other, and then retains the changed printing condition in the memory 207.

Additionally, while, in the second exemplary embodiment, an example of estimating, from an input-image toner image formed in a printing condition different from that for a patch toner image, a color tone in the same printing condition as that for the patch toner image and displaying color tone variations in the same printing condition has been described, the printing condition available for displaying color tone variations is not limited to such example. It is desirable to be able to display, in addition to color tone variations in the same printing condition, color tone variations in a printing condition for a region designated by the user different from that for the patch toner image. In addition to comparing color tone variations in the same printing condition on the image bearing member 308 and on the recording medium 503 with each other, comparing color tone variations in the respective different printing conditions on the recording medium 503 with each other enables more limiting factors for variations.

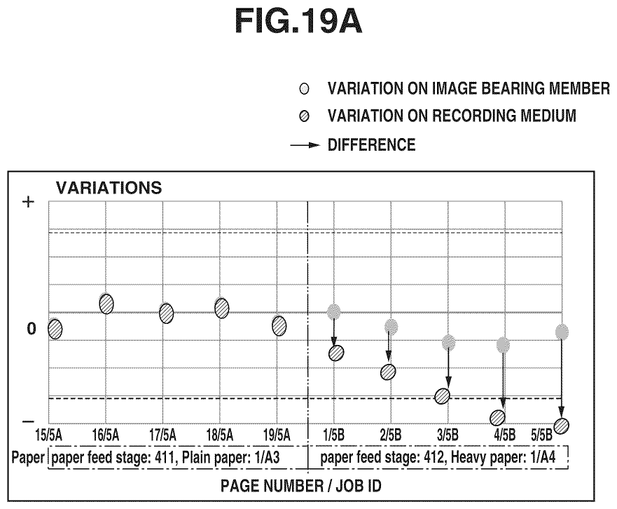

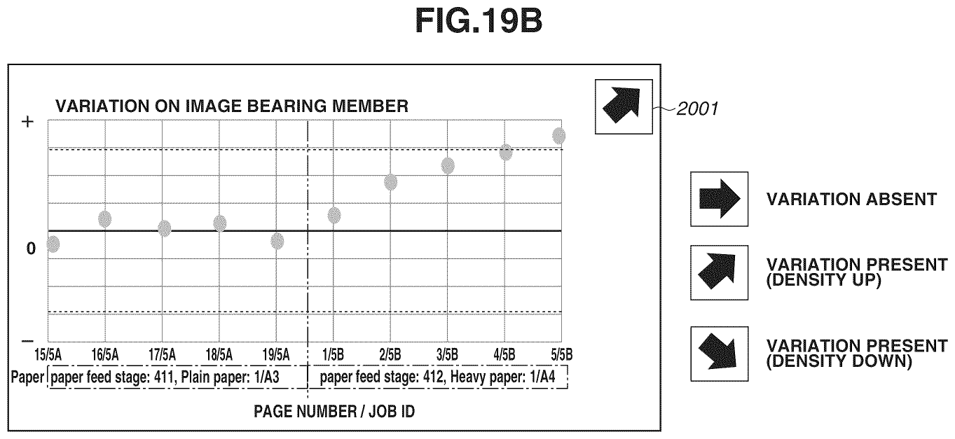

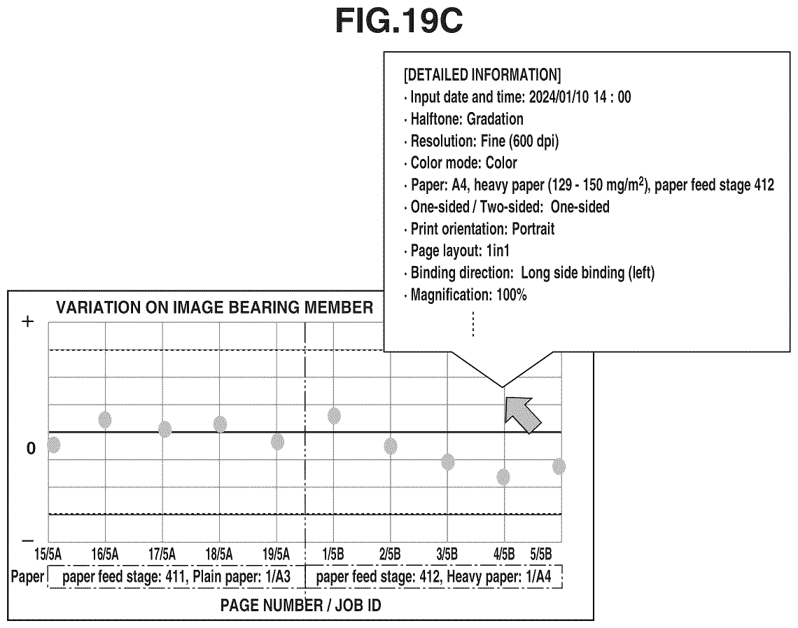

Furthermore, in each of the first exemplary embodiment and the second exemplary embodiment, an example of displaying variations and a difference side by side has been described, each of the first exemplary embodiment and the second exemplary embodiment is not limited to such example. As illustrated in the schematic view of FIG. 19A, the display method of displaying variations in the respective printing processes and a difference therebetween can be changed to a method of displaying those in a superimposed manner. Moreover, as a more favorable display method, a display method of displaying the presence or absence of a variation or the directions of a variation (density up or density down) with an icon 2001 such as that illustrated in the screen schematic view of FIG. 19B, thus enabling the user to easily recognize the displayed content, can be employed.

Furthermore, while an example of displaying paper information as a difference in print settings for each print job has been described, more favorably, in one embodiment, a difference in information is able to check, such as a condition for halftone processing at the time of printing or an RIP resolution. For example, in one embodiment, a configuration is employed in which, when the user has hovered an operation cursor over a variation display portion, the details of print settings are popped up as illustrated in FIG. 19C. Performing pop-up displaying enables specifying variation factors with a difference in print settings other than the paper condition also taken into consideration.

Furthermore, the aspect of the embodiments can be applied to a system configured with a plurality of pieces of equipment, such as a host computer, interface equipment, a reader, and a printer, and, moreover, can be applied to an apparatus composed of a single piece of equipment, such as a copying machine or a facsimile apparatus.

The disclosure can also be implemented by processing for supplying a program for implementing one or more functions of the above-described exemplary embodiments to a system or apparatus via a network or a storage medium and causing one or more processors included in a computer of the system or apparatus to read out and execute the program. Moreover, the disclosure can also be implemented by a circuit which implements one or more functions of the above-described exemplary embodiments (for example, an application specific integrated circuit (ASIC)).

While various examples and exemplary embodiments of the disclosure have been described above, the gist and scope of the disclosure should not be construed to be limited to specific descriptions in the specification.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-110603 filed Jul. 9, 2024, which is hereby incorporated by reference herein in its entirety.

What is claimed is:

1. A system including a printer which performs printing on a recording medium according to a print job, the system comprising:
a display configured to display information; and
a controller having one or more processors which execute instructions stored in one or more memories, the controller being configured to:
acquire first color tones, on a member halfway through print processing, of at least a first print job and a second print job; and
acquire second color tones, on the recording medium subjected to printing, of at least the first print job and the second print job,
wherein the display displays first color information that is based on the first color tones of at least the first print job and the second print job and second color information that is based on the second color tones of at least the first print job and the second print job.

2. The system according to claim 1,
wherein the controller is further configured to:
calculate a difference between each of the first color tones of at least the first print job and the second print job and a first criterion value; and
calculate a difference between each of the second color tones of at least the first print job and the second print job and a second criterion value,
wherein the first color information includes the calculated difference between each of the first color tones of at least the first print job and the second print job and the first criterion value, and
wherein the second color information includes the calculated difference between each of the second color tones of at least the first print job and the second print job and the second criterion value.

3. The system according to claim 2, further comprising a storage configured to store the calculated difference between the first color tone of the first print job and the first criterion value included in the first color information and the calculated difference between the second color tone of the first print job and the second criterion value included in the second color information.

4. The system according to claim 3,
wherein the first print job is a print job which has previously been executed, and
wherein the second print job is a print job which is being executed.

5. The system according to claim 1, wherein the display further displays third color information indicating a difference between the first color information and the second color information.

6. The system according to claim 1, wherein each of the first color tones and the second color tones includes at least one of a toner application amount, a density, a lightness, a saturation, and a hue.

7. The system according to claim 1, wherein each of the first color information and the second color information includes at least one of a difference between a criterion value and a toner application amount, a difference between a criterion value and a density, a lightness difference from a criterion value a saturation difference from a criterion value, a hue difference from a criterion value, and a color difference from a criterion value.

8. The system according to claim 5, wherein the controller is further configured to determine necessity of one or more adjustments for stabilizing colors of a printed product, based on the third color information.

9. The system according to claim 8, wherein the controller is further configured to perform at least one of correction of a maximum density, gradation correction, and adjustment of a secondary transfer voltage for each toner color.

10. The system according to claim 1, wherein the controller is further configured to acquire the first color tone from a patch toner image included in a toner image on the member and acquire the second color tone from a patch printed on the recording medium.

11. The system according to claim 8,
wherein the controller is further configured to:
acquire a temperature or humidity inside an apparatus including the printer; and
determine necessity of the one or more adjustments based on, in addition to the first color information and the second color information, the temperature or humidity.

12. The system according to claim 1, wherein the display changes a toner color and a toner density to be displayed, according to a designation made by a user or the first color information and the second color information.

13. The system according to claim 1, wherein a unit of reference to the first color information and the second color information is at least one of page, print job, and printing date and time.

14. The system according to claim 1, wherein the controller is further configured to acquire color tones from respective different patch toner images.

15. The system according to claim 1, wherein the display includes a plurality of display regions, and displays the first color information and the second color information in respective different display regions of the display.

16. The system according to claim 1, wherein the controller is further configured to, according to a printing condition of a patch toner image on the member, acquire a color tone from a position, in a printing condition corresponding to the printing condition of the patch toner image, of an input-image toner image corresponding to image data included in the print job.

17. The system according to claim 1, wherein the controller is further configured to change a printing condition of a patch toner image on the member according to a printing condition in a position for acquiring a color tone of an input-image toner image corresponding to image data included in the print job.

18. The system according to claim 1, wherein the display includes a plurality of icons according to variations of values in the first color information and the second color information, and displays the icons associated with the variations.

19. A method for an apparatus including a printing unit which performs printing on a recording medium according to an input print job, the method comprising:
acquiring first color tones on a member halfway through print processing in a first print job and a second print job;
acquiring second color tones on the recording medium subjected to printing in the first print job and the second print job; and
displaying, on a display unit configured to display color information based on the acquired color tones, first color information that is based on the first color tones of at least the first print job and the second print job and second color information that is based on the second color tones of at least the first print job and the second print job.

20. A non-transitory computer-readable storage medium configured to store a program causing a computer to execute a method for an apparatus including a printing unit which performs printing on a recording medium according to an input print job, the method comprising:
acquiring first color tones on a member halfway through print processing in a first print job and a second print job;
acquiring second color tones on the recording medium subjected to printing in the first print job and the second print job; and
displaying, on a display unit configured to display color information based on the acquired color tones, first color information that is based on the first color tones of at least the first print job and the second print job and second color information that is based on the second color tones of at least the first print job and the second print job.
